(19) United States
(12) Patent Application Publication
(10) Pub. No.: US 2026/0217885 A1
(43) Pub. Date: Jul. 30, 2026

(54) POLYMER AND POLYMER EMULSION, PREPARATION METHOD THEREFOR, CEMENT SLURRY, AND APPLICATION OF POLYMER AND POLYMER EMULSION

(71) Applicants: CHINA PETROLEUM & CHEMICAL CORPORATION, Beijing (CN); SINOPEC PETROLEUM ENGINEERING TECHNOLOGY RESEARCH INSTITUTE CO., LTD, Beijing (CN)

(72) Inventors: Min ZENG, Beijing (CN); Qichun WANG, Beijing (CN); Shiming ZHOU, Beijing (CN); Xiaojing WANG, Beijing (CN); Lishuang WANG, Beijing (CN); Haoguang WEI, Beijing (CN); Xia MIAO, Beijing (CN)

(21) Appl. No.: 19/145,552

(22) PCT Filed: Dec. 29, 2023
(86) PCT No.: PCT/CN2023/143470

§ 371 Date: Jul. 3, 2025

(30) Foreign Application Priority Data
Jan. 3, 2023 (CN) 202310002812.9

(51) Int. Cl. C08F 212/08; C04B 24/16; C08F 2/24; C08F 212/36

(52) U.S. Cl. CPC C08F 212/08; C08F 2/24; C08F 212/36; C04B 24/163

(57) ABSTRACT

A polymer, an emulsion, and a preparation method and application therefor, and a cement slurry are provided. The polymer contains a benzene ring, a hydrophilic structure, and a C6-C23 alkyl side chain. The a molar ratio of the benzene ring to the hydrophilic structure to the alkyl side chain is (20-70):(1-10):(20-80); and the degree of cross-linking of the polymer is 1-10%. The polymer has a high oil and gas absorption rate, and a good heat resistance, durability and mechanical properties. When the polymer is used in a cement slurry, a cement slurry having uniform dispersion and stable performance can be obtained.

### CROSS-REFERENCE TO RELATED APPLICATIONS

The application claims the benefit of the Chinese patent application No. “202310002812.9”, filed on Jan. 3, 2023, the content of which is specifically and entirely incorporated herein by reference.

### TECHNICAL FIELD

The present invention relates to the technical field of cement slurry materials for well cementation in the oil and gas field, in particular to a polymer, a polymer emulsion, a preparation method therefor, and a cement slurry and its applications.

### BACKGROUND ART

The deep and unconventional oil and gas field well cementation engineering confronts complex working conditions such as high temperature, high pressure, high acidity, and large-scale hydraulic fracturing, conventional cement stone has brittleness, porosity, easy corrosion, and other defects, it may suffer from the dynamic load damage, cementation deterioration, and other physical and chemical damages, which causes the safety and environmental issues such as gas-channeling, annulus pressure, and methane leakage, thereby forming the world-class challenges.

Some companies have used the serial cement slurry system of FLEXSTONE, SELFHEALING, and the accompanying process to control and alleviate the annular channeling to a certain degree; some companies have developed anti-channeling cement slurry systems with swelling and toughness, but the application ranges are limited by the large size and single function of the auxiliary materials.

Furthermore, the polymer used in the stimulus-responsive polymer technology is generally composed of oil-absorbing resin or elastomer rubber latex, although the polymer has a desirable self-healing effect, the polymer has poor heat resistance and durability in the high-temperature and strong alkaline environment of cement slurry, which imposes limitations to its applications in the engineering field.

CN104177555B discloses an oil-absorbing and expansion material consisting of acrylic ester latex obtained by using acrylate monomers as the raw material and acetate ester emulsion produced by using vinyl acetate monomers as the raw material, but the polyacrylate chain segment is hydrolyzed to a polyacrylic acid chain segment at the temperature above 120° C., resulting in the ultra-slow coagulation of the cement slurry. Although the phenomenon can be alleviated by increasing the ratio of long-chain acrylate, it cannot be eradicated. In addition, the vinyl acetate emulsion has a similar problem.

Because of the aforementioned defects, it is urgent to develop a self-healing polymer latex that swells upon contacting with natural gas, has high-temperature resistance, and is applicable to the cement slurry for well cementation in the oil and gas fields.

### SUMMARY OF THE INVENTION

The present invention aims to overcome the defects in the prior art that the polymer latex has poor high-temperature resistance, the cement slurry for well cementation has unstable properties, and the cement stone obtained from curing of said cement slurry has a low flexural strength, and disclose a polymer, a polymer emulsion, and a preparation method therefor, and a cement slurry and its applications.

To achieve the above objects, the first aspect of the present invention discloses a polymer comprising a benzene ring, a hydrophilic structure, a C₆-C₂₃ alkyl side chain, wherein a molar ratio of the benzene ring to the hydrophilic structure to the alkyl side chain is (20-70):(1-10):(20-80);

the polymer has a degree of cross-linking within a range of 1-10%.

The second aspect of the present invention discloses a polymer emulsion comprising latex particles and an emulsifier;
wherein the latex particles are composed of the aforementioned polymer.

The third aspect of the present invention discloses a method for preparing a polymer emulsion comprising:
(1) blending a mixed monomers, a emulsifier, and water to obtain a monomer emulsion;
(2) irradiating the monomer emulsion to carry out a polymerization to obtain a polymer emulsion;
wherein the mixed monomers comprise a monomer A, a monomer B, a cross-linker C, and a monomer D;
wherein the monomer A is represented by CH₂═CH₂—R, wherein the group R is a C₆-C₂₃ alkyl; the monomer B comprises a benzene ring; the monomer D contains a hydrophilic structure;
the monomer A, the monomer B, and the monomer D are used in such amounts that a molar ratio of the benzene ring, the hydrophilic structure, and the group R is (20-70):(1-10):(20-80);
wherein a irradiation absorption dose is within a range of 10 kGy-50 kGy.

The fourth aspect of the present invention discloses a polymer emulsion prepared with the aforementioned method.

The fifth aspect of the present invention discloses a method of using the aforementioned polymer and/or the aforementioned polymer emulsion as a cement slurry self-healing agent.

The sixth aspect of the present invention discloses a cement slurry, wherein the cement slurry comprises the above-mentioned polymer and/or polymer emulsion.

The seventh aspect of the present invention discloses a method of using the aforementioned cement slurry in well cementation.

Due to the above technical scheme, the polymer disclosed in the present invention contains a benzene ring, a hydrophilic group, and a C₆-C₂₃ alkyl side chain, the three components have a specific molar ratio, and the polymer has a specific degree of cross-linking, such that the polymer has high oil and gas absorption rate, and good heat resistance, durability and mechanical properties. When the polymer is used in a cement slurry, a cement slurry having uniform dispersion and stable performance can be obtained; after the cement slurry is cured, the formed cement stone has an elastic modulus that is greatly reduced compared with that of conventional cement stone, the flexural strength of the hardened cement stone is improved, the gas permeability of the cement stone is reduced and the hardened cement stone has a self-repairing performance when encountering oil and gas, and therefore the long-term sealing performance of the cement sheath is ensured.

The polymer emulsion disclosed by the present invention comprises a polymer disclosed by the present invention and an emulsifier, compared to the polymer emulsion in the prior art, the polymer emulsion disclosed by the present invention has desirable compatibility with cement slurry at high-temperature, and can significantly increase the application temperature of cement slurry.

If the polymer disclosed by the present invention and/or a polymer emulsion containing the polymer as the latex particles are added into the cement slurry as a cement slurry self-healing agent, obtaining a cement slurry having uniform dispersion and stable performance; after the cement slurry is cured, the formed cement stone has an elastic modulus that is greatly reduced compared with that of a conventional cement stone, the flexural strength of the hardened cement stone is improved, the gas permeability of the cement stone is reduced, and the cement stone has a self-repairing performance when encountering oil and gas, thereby ensuring the long-term sealing performance of the cement sheath.

### BRIEF DESCRIPTION OF THE DRAWINGS

FIG. 1a illustrates an infrared spectrogram of the polymer obtained in Example 1;

FIG. 1b illustrates an infrared spectrogram of the emulsifier component A in the polymer emulsion obtained in Example 1;

FIG. 1c illustrates an infrared spectrogram of the emulsifier component B in the polymer emulsion obtained in Example 1;

FIG. 2 shows a nuclear magnetic spectrogram of the polymer obtained in Example 1.

FIG. 3 shows a DSC curve of the polymer obtained in Example 1;

FIG. 4 illustrates an SEM photograph of the polymer emulsion obtained in Example 1;

FIG. 5a illustrates an NMR spectrogram of the emulsifier component A in the polymer emulsion obtained in Example 1;

FIG. 5b shows an MS spectrogram of the emulsifier component A in the polymer emulsion obtained in Example 1;

FIG. 6a illustrates an NMR spectrogram of the emulsifier component B in the polymer emulsion obtained in Example 1;

FIG. 6b shows an MS spectrogram of the emulsifier component B in the polymer emulsion obtained in Example 1.

### DESCRIPTION OF THE PREFERRED EMBODIMENT

The terminals and any value of the ranges disclosed herein are not limited to the precise ranges or values, such ranges or values shall be comprehended as comprising the values adjacent to the ranges or values. As for numerical ranges, the endpoint values of the various ranges, the endpoint values and the individual point values of the various ranges, and the individual point values may be combined with one another to produce one or more new numerical ranges, which should be deemed to have been specifically disclosed herein.

In the first aspect, the present invention discloses a polymer comprising a benzene ring, a hydrophilic structure, and a C₆-C₂₃ alkyl side chain, wherein a molar ratio of the benzene ring to the hydrophilic structure to the alkyl side chain is (20-70):(1-10):(20-80);

the polymer has a degree of cross-linking within a range of 1-10%.

In the present invention, the polymer contains a benzene ring, a hydrophilic group, and a C₆-C₂₃ alkyl side chain, the three components have a specific molar ratio, and the polymer has a specific degree of cross-linking, such that the polymer has high oil and gas absorption rate, and good heat resistance, durability and mechanical properties; when the polymer is used in a cement slurry, the cement stone obtained after curing of the cement slurry can swell upon contacting with oil and gas, and has excellent high-temperature resistance.

In the present invention, the polymer comprises a C₆-C₂₃ alkyl side chain, so that the polymer can be applied in the cement slurry as a cement slurry self-healing fluid, it can reduce permeability of the cement stone, decrease the gas channeling probability, increase the retention time of natural gas in the latex film obtained after a drying process of the polymer, and improve the response speed of cement stone to natural gas. If an oil absorption swelling material is prepared by using an acrylate monomer as the feedstock, it lacks the high-temperature resistance, resulting in ultra-slow coagulation of the cement slurry. If an alkyl side chain having less than 6 carbon atoms is selected, the finished product has a low oil absorption rate, the cement stone has a high gas permeability, its oil-gas response deteriorates, and the self-repairing performance when encountering oil and gas is poor.

In the present invention, the molar ratio of the benzene ring, the hydrophilic structure, and the alkyl side chain in the polymer is measured by the Fourier Transform Infrared Spectroscopy (FTIR), Nuclear Magnetic Resonance (NMR), Differential Scanning calorimetry (DSC), and Inductively Coupled Plasma-Optical Emission Spectrometer (ICP-OES).

In the present invention, the degree of cross-linking of the polymer is measured by a balanced swelling method. Specifically, the polymer sample is weighed by using an analytical balance and then placed in a swelling meter. Benzene is added in an amount of one-third of the test tube, the test tube plug is fastened down, and the test tube is subsequently placed in a constant-temperature water bath at 25° C. for swelling. The mass of the sample is measured every 8 h, the swelling body is taken out gently, the benzene attached to the surface of the sample is rapidly dried with a filter paper, the sample is placed immediately into a weighing bottle, the bottle plug is closed and the sample is then weighed, the sample is placed back into the swelling tube such that the swelling process is continued until the mass difference between the two measurements does not exceed 0.01 g, it is considered that the swelling process reaches an equilibrium. The swelling degree Q is calculated according to the following formula:

$$Q = ( \frac{{w}_{1}}{{ρ}_{1}} + \frac{{w}_{2}}{{ρ}_{2}} ) / \frac{{w}_{2}}{{ρ}_{2}}$$

w₁ and w₂ denote the mass of benzene and polymer in the swelling body respectively, ρ₁ and ρ₂ denote the benzene density and the polymer density before the swelling process respectively.

The degree of cross-linking of the polymer is calculated based on the following formula:

$$\overline{{M}_{C}} = ρ \overline{{V}_{1}} {Q}^{5 / 3} / ( 1 - 1 / {χ}_{1} )$$

M̅_̅{̅c̅}̅ denotes the degree of cross-linking, ρ denotes the polymer density, Q denotes the swelling degree, V̅₁̅ denotes the molar volume of benzene, and χ₁ denotes the interaction coefficient of A benzene with the polymer.

In the present invention, a molar ratio of the benzene ring to the hydrophilic structure to the alkyl side chain is (20-70):(1-10):(20-80), for example, it may be 20:1:20, 20:1:25, 20:1:30, 20:1:35, 20:1:40, 20:1:45, 20:1:50, 20:1:55, 20:1:60, 20:1:65, 20:1:70, 20:1:75, 20:1:80, 20:2:20, 20:3:20, 20:4:20, 20:5:20, 20:6:20, 20:7:20, 20:8:20, 20:9:20, 20:10:20, 25:1:20, 30:1:20, 35:1:20, 40:1:20, 45:1:20, 50:1:20, 55:1:20, 60:1:20, 65:1:20, 70:1:20, and a random value within the range consisting of any two numerical values, preferably, a molar ratio of the benzene ring to the hydrophilic structure to the alkyl side chain is (20-50):(1-5):(40-80).

In the present invention, the polymer has a degree of cross-linking within a range of 1-10%, the degree of cross-linking may be, for example, 1%, 1.5%, 2%, 2.5%, 3%, 3.5%, 4%, 4.5%, 5%, 5.5%, 6%, 6.5%, 7%, 7.5%, 8%, 8.5%, 9%, 9.5%, 10%, and a random value within the range consisting of any two numerical values. Further, the polymer has a degree of cross-linking within a range of 2-5%.

In some specific embodiments of the present invention, the alkyl side chain is selected from C₆-C₁₈ alkyl side chain; preferably one or more selected from the group consisting of a C₆ alkyl side chain, a C₁₂ alkyl side chain, a C₁₄ alkyl side chain, a C₁₆ alkyl side chain, and a C₁₈ alkyl side chain.

In the present invention, the alkyl side chain may be a straight chain alkyl side chain or a branched chain alkyl side chain.

According to the present invention, the hydrophilic structure is at least one derived from the amide group, sulfonic acid group, sulfonate group, carboxyl, carboxylate, phosphoric acid, phosphate group, and a polyether.

In the present invention, the selection of the specific kind of hydrophilic groups enables the polymer to have characteristics such as strong alkali resistance, high-temperature resistance, and resistance to high concentrations of Ca²⁺ ions, thereby significantly improving compatibility between the polymer and the cement slurry.

Further, the hydrophilic group is selected from the amide group and/or sulfonate group.

According to the present invention, the polymer comprises a structural unit A from long-chain olefins, a structural unit B from styrene, a structural unit C from a crosslinker monomer, and a structural unit D from a hydrophilic monomer.

In some specific embodiments of the present invention, the long chain olefin is one or more selected from C₈-C₂₅ α-olefins; preferably, the long chain olefin is one or more selected from C₈-C₂₀ α-olefins, more preferably one or more selected from 1-octaene, 1-tetradecene, 1-hexadecene, 1-octadecene, and 1-eicosene. When the long chain olefin in the present invention is used, the prepared polymer emulsion can be applied in the cement slurry as a cement slurry self-healing fluid, it can reduce the permeability of the cement stone, decrease the gas channeling probability, increase the retention time of natural gas in the latex film obtained after a drying process of the polymer, and improve the response speed of cement stone to natural gas. If an oil absorption swelling material is prepared by using an acrylate monomer as the feedstock, it lacks the high-temperature resistance, resulting in ultra-slow coagulation of the cement slurry. If an alkyl side chain having less than 8 carbon atoms is selected, the finished product has a low oil absorption rate, the cement stone has a high gas permeability, its oil-gas response deteriorates, and the self-repairing performance when encountering oil and gas is poor.

In some specific embodiments of the present invention, the crosslinker monomer is selected from oil-soluble crosslinkers, preferably the crosslinker monomer is polymerizable monomers containing at least two carbon-carbon double bonds, for example, including but not limited to divinyl benzene and/or N,N-methylenebisacrylamide, more preferably divinyl benzene.

In some specific embodiments of the present invention, the hydrophilic monomer is one or more selected from the group consisting of 2-acrylamido-2-methylpropanesulfonic acid, acrylamide, methacrylic sulfonate, vinyl sulfonate, allyl-containing alkyl alcohol ether sulfosuccinate diester sodium salt, methacrylic acid polyether phosphate ester, and methoxy polyethylene glycol methacrylate, to improve the stability of polymer emulsion in a high-temperature and strong alkali system, thereby enhancing the mechanical stability, high-temperature stability in a cement slurry. The salt may be one or more of potassium salt, sodium salt, and ammonium salt.

In a preferred embodiment of the present invention, the hydrophilic monomer is selected from the group consisting of methoxy polyethylene glycol methacrylate, acrylamide in combination with 2-acrylamido-2-methylpropanesulfonic acid and/or methacrylic sulfonate, wherein the methoxy polyethylene glycol methacryla is contained in an amount of 0.5-5 wt %, for example, it may be 0.5 wt %, 1 wt %, 1.5 wt %, 2 wt %, 2.5 wt %, 3 wt %, 3.5 wt %, 4 wt %, 4.5 wt %, 5 wt %, and a random value within the range consisting of any two numerical values; the acrylamide is contained in an amount of 0.5-5 wt %, for example, it may be 0.5 wt %, 1 wt %, 1.5 wt %, 2 wt %, 2.5 wt %, 3 wt %, 3.5 wt %, 4 wt %, 4.5 wt %, 5 wt %, and a random value within the range consisting of any two numerical values, based on the total weight of the hydrophilic monomer.

In the present invention, the structural units are repeating units formed in the polymer through the addition polymerization of a carbon-carbon double bond of olefin in each of the long chain olefin, the styrene, the crosslinker monomer, and the hydrophilic monomer respectively.

In some specific embodiments of the present invention, the structural unit A is contained in an amount of 5-80 wt %, the structural unit B is contained in an amount of 10-90 wt %, the structural unit C is contained in an amount of 0.5-5 wt %, and the structural unit D is contained in an amount of 0.5-5 wt %, based on the total weight of the polymer.

In the present invention, when the content of each structural unit in the polymer is controlled to fall into the above ranges, the polymer has a high oil and gas adsorption rate, excellent heat resistance, durability, and mechanical properties, when the polymer is used in a cement slurry, the gas permeability and flexural strength of the cement stone in the high-temperature environment can be significantly improved. When the content of each structural unit in the polymer is not within the above ranges, the gas permeability of the cement stone is high, and the flexural strength is reduced; after the cement stone generates cracks, the plugging process is slow, or even the plugging cannot be formed, thus the long-term sealing performance of the cement sheath cannot be guaranteed.

In the present invention, the total content of the structural unit A, the structural unit B, the structural unit C, and the structural unit D is 100 wt %.

In the present invention, the structural unit A is contained in an amount of 5-80 wt %, for example, it may be 5 wt %, 6 wt %, 7 wt %, 8 wt %, 9 wt %, 10 wt %, 11 wt %, 12 wt %, 13 wt %, 14 wt %, 15 wt %, 16 wt %, 17 wt %, 18 wt %, 19 wt %, 20 wt %, 21 wt %, 22 wt %, 23 wt %, 24 wt %, 25 wt %, 26 wt %, 27 wt %, 28 wt %, 29 wt %, 30 wt %, 31 wt %, 32 wt %, 33 wt %, 34 wt %, 35 wt %, 36 wt %, 37 wt %, 38 wt %, 39 wt %, 40 wt %, 41 wt %, 42 wt %, 43 wt %, 44 wt %, 45 wt %, 46 wt %, 47 wt %, 48 wt %, 49 wt %, 50 wt %, 51 wt %, 52 wt %, 53 wt %, 54 wt %, 55 wt %, 56 wt %, 57 wt %, 58 wt %, 59 wt %, 60 wt %, 61 wt %, 62 wt %, 63 wt %, 64 wt %, 65 wt %, 66 wt %, 67 wt %, 68 wt %, 69 wt %, 70 wt %, 71 wt %, 72 wt %, 73 wt %, 74 wt %, 75 wt %, 76 wt %, 77 wt %, 78 wt %, 79 wt %, 80 wt %, and a random value within the range consisting of any two numerical values; the structural unit B is contained in an amount of 10-90 wt %, it may be, for example, 10 wt %, 11 wt %, 12 wt %, 13 wt %, 14 wt %, 15 wt %, 16 wt %, 17 wt %, 18 wt %, 19 wt %, 20 wt %, 21 wt %, 22 wt %, 23 wt %, 24 wt %, 25 wt %, 26 wt %, 27 wt %, 28 wt %, 29 wt %, 30 wt %, 31 wt %, 32 wt %, 33 wt %, 34 wt %, 35 wt %, 36 wt %, 37 wt %, 38 wt %, 39 wt %, 40 wt %, 41 wt %, 42 wt %, 43 wt %, 44 wt %, 45 wt %, 46 wt %, 47 wt %, 48 wt %, 49 wt %, 50 wt %, 51 wt %, 52 wt %, 53 wt %, 54 wt %, 55 wt %, 56 wt %, 57 wt %, 58 wt %, 59 wt %, 60 wt %, 61 wt %, 62 wt %, 63 wt %, 64 wt %, 65 wt %, 66 wt %, 67 wt %, 68 wt %, 69 wt %, 70 wt %, 71 wt %, 72 wt %, 73 wt %, 74 wt %, 75 wt %, 76 wt %, 77 wt %, 78 wt %, 79 wt %, 80 wt %, 81 wt %, 82 wt %, 83 wt %, 84 wt %, 85 wt %, 86 wt %, 87 wt %, 88 wt %, 89 wt %, 90 wt %, and a random value within the range consisting of any two numerical values; the structural unit C is contained in an amount of 0.5-5 wt %, for example, it may be 0.5 wt %, 1 wt %, 1.5 wt %, 2 wt %, 2.5 wt %, 3 wt %, 3.5 wt %, 4 wt %, 4.5 wt %, 5 wt %, and a random value within the range consisting of any two numerical values; the structural unit D is contained in an amount of 0.5-5 wt %, for example, it may be 0.5 wt %, 1 wt %, 1.5 wt %, 2 wt %, 2.5 wt %, 3 wt %, 3.5 wt %, 4 wt %, 4.5 wt %, 5 wt %, and a random value within the range consisting of any two numerical values, based on the total weight of the polymer.

Further, structural unit A is contained in an amount of 30-60 wt %, structural unit B is contained in an amount of 40-70 wt %, structural unit C is contained in an amount of 1.5-3.5 wt %, and structural unit D is contained in an amount of 1.5-2.5 wt %, based on the total weight of the polymer.

In the present invention, the content of each structural unit in the polymer is measured by the Fourier Transform Infrared Spectroscopy (FTIR) and Nuclear Magnetic Resonance (NMR).

In the present invention, the polymer in a preferred specific embodiment may be one selected from the following polymers:

polymer-1 contains a structural unit A from 1-octaene, a structural unit B from styrene, a structural unit C from divinyl benzene, and a structural unit D from acrylamide and 2-acrylamido-2-methylpropanesulfonic acid. Further preferably, the mass ratio of structural unit A:structural unit B:structural unit C:structural unit D is 44.4:40:2.2:2.4.

Polymer-2 contains a structural unit A from 1-hexadecene, a structural unit B from styrene, a structural unit C from divinyl benzene, and a structural unit D from acrylamide and 2-acrylamide-2-methylpropanesulfonic acid. Further preferably, the mass ratio of structural unit A:structural unit B:structural unit C:structural unit D is 40:44.4:1.8:2.2.

Polymer-3 contains a structural unit A from 1-eicosene, a structural unit B from styrene, a structural unit C from divinyl benzene, and a structural unit D from acrylamide and sodium methacrylic sulfonate. Further preferably, the mass ratio of structural unit A:structural unit B:structural unit C:structural unit D is 32:64:2.4:2.

In the present invention, the content of acrylamide is preferably 20-80 wt % of the total amount of the structural units D, for example, the content may be 20 wt %, 21 wt %, 22 wt %, 23 wt %, 24 wt %, 25 wt %, 26 wt %, 27 wt %, 28 wt %, 29 wt %, 30 wt %, 31 wt %, 32 wt %, 33 wt %, 34 wt %, 35 wt %, 36 wt %, 37 wt %, 38 wt %, 39 wt %, 40 wt %, 41 wt %, 42 wt %, 43 wt %, 44 wt %, 45 wt %, 46 wt %, 47 wt %, 48 wt %, 49 wt %, 50 wt %, 51 wt %, 52 wt %, 53 wt %, 54 wt %, 55 wt %, 56 wt %, 57 wt %, 58 wt %, 59 wt %, 60 wt %, 61 wt %, 62 wt %, 63 wt %, 64 wt %, 65 wt %, 66 wt %, 67 wt %, 68 wt %, 69 wt %, 70 wt %, 71 wt %, 72 wt %, 73 wt %, 74 wt %, 75 wt %, 76 wt %, 77 wt %, 78 wt %, 79 wt %, 80 wt %, and a random value within the range consisting of any two numerical values.

The second aspect of the present invention discloses a polymer emulsion, wherein the polymer emulsion comprises latex particles and an emulsifier;

wherein the latex particles are composed of the aforementioned polymer.

In the present invention, the polymer emulsion comprises latex particles of the polymer and an emulsifier; the latex particles of the polymer simultaneously contain a benzene ring, a hydrophilic group, and a C₆-C₂₃ alkyl side chain, the three components have a specific molar ratio, and the polymer has a specific degree of cross-linking, such that the polymer has high oil-gas expansion rate upon contacting with oil and gas, high mechanical properties, and good compatibility with the cement slurry when the polymer emulsion is used in the cement slurry, it enables the cement slurry to rapidly heal and reduces the elastic modulus of the cement stone obtained from curing of said cement slurry.

Specifically, the polymer emulsion disclosed by the present invention can be used for preparing a cement slurry for well cementation with good heat resistance, and the cement stone obtained from curing said cement slurry has a lower elastic modulus and a desirable self-repairing performance when encountering oil and gas. In the prior art, the cement slurry prepared by using the acetate emulsion cannot be used in a high-temperature environment; when the dosage of the mixed monomer goes beyond the dosage range of the present invention, the self-repairing performance of the cement stone obtained after the curing process is poor, namely the flow rate of the natural gas at cracks of the cement stone is reduced slowly.

In some specific embodiments of the present invention, the latex particles have an average particle size within a range of 70-200 nm.

In the present invention, when the latex particles in the polymer latex are controlled to have the above-mentioned particle size, the water loss properties of the cement slurry containing the polymer emulsion can be reduced.

In the present invention, the latex particles have an average particle size within a range of 70-200 nm, for example, the average particle size may be 70 nm, 80 nm, 90 nm, 100 nm, 110 nm, 120 nm, 130 nm, 140 nm, 150 nm, 160 nm, 170 nm, 180 nm, 190 nm, 200 nm, and a random value within the range consisting of any two numerical values; preferably, the latex particles have an average particle size within the range of 100-180 nm.

In the present invention, the average particle size of the latex particles is measured by a laser particle size method, in particular, the polymer emulsion is diluted by deionized water until the concentration of the latex particles is 0.01 wt %; the particle size is measured according to the operating instructions of the laser particle analyzer.

According to the present invention, the polymer emulsion has a density within a range of 1-1.05 g/cm³, the density may be, for example, 1 g/cm³, 1.01 g/cm³, 1.02 g/cm³, 1.03 g/cm³, 1.04 g/cm³, 1.05 g/cm³, and a random value within the range consisting of any two numerical values.

According to the present invention, the polymer emulsion has a solid content within a range of 35-60 wt %, for example, the solid content may be 35 wt %, 40 wt %, 45 wt %, 50 wt %, 55 wt %, 60 wt %, and a random value within the range consisting of any two numerical values, preferably within the range of 40-50 wt %.

According to the present invention, the polymer emulsion has an apparent viscosity within a range of 20-35 mPa·s at 25° C., for example, the apparent viscosity may be 20 mPa·s, 25 mPa·s, 30 mPa·s, 35 mPa·s, and a random value within the range consisting of any two numerical values, preferably within the range of 30-35 mPa·s.

In the present invention, when at least one of the density, solid content, or apparent viscosity of the polymer emulsion falls into the above ranges, the compatibility between the polymer emulsion and the cement slurry can be significantly improved.

According to the present invention, a content of the latex particles is 35-60 parts by weight, and a content of the emulsifier is 0.5-5 parts by weight, based on 100 parts by weight of the polymer emulsion.

In the present invention, if the contents of the latex particles and the emulsifier in the polymer emulsion fall into the aforementioned ranges, the polymer emulsion and the cement slurry have a desirable compatibility, and the cement slurry containing the polymer emulsion is not apt to foam.

In the present invention, the contents of the emulsifier and the latex particles in the polymer emulsion are measured according to the following methods:

drying and crushing the polymer emulsion, washing with acetone, drying the powder, and weighing to obtain the content of latex particles in the polymer emulsion; then drying the leachate obtained from the washing process, and weighing to obtain the total content of the emulsifier in the polymer emulsion.

In the present invention, based on 100 parts by weight of the polymer emulsion, a content of the latex particles is 35-60 parts by weight, for example, it may be 35 parts by weight, 40 parts by weight, 45 parts by weight, 50 parts by weight, 55 parts by weight, 60 parts by weight, and a random value within the range consisting of any two numerical values; a content of the emulsifier is 0.5-5 parts by weight, it can be, for example, 0.5 part by weight, 1 part by weight, 1.5 parts by weight, 2 parts by weight, 2.5 parts by weight, 3 parts by weight, 3.5 parts by weight, 4 parts by weight, 4.5 parts by weight, 5 parts by weight, and a random value within the range consisting of any two numerical values.

Further, the content of the latex particles is 40-50 parts by weight, and the content of the emulsifier is 1-3 parts by weight, based on 100 parts by weight of the polymer emulsion.

According to the present invention, the emulsifier is selected from anionic surfactants and/or nonionic surfactants.

In the present invention, the specific type of the emulsifier in the polymer emulsion is measured by infrared spectrometry, specifically, the infrared spectrometry comprises drying and crushing the polymer emulsion, washing with acetone, drying the leachate, then carrying out infrared spectrometry, Nuclear Magnetic Resonance (NMR) testing, and Mass Spectrometry (MS) to determine the type of the emulsifier and the specific dosage of each emulsifier.

According to the present invention, the anionic surfactant is at least one selected from the group consisting of sodium dodecylbenzene sulfonate, sodium dodecyl sulfate, sodium alkylphenol ether sulfosuccinate, alkylphenol phosphate, and alkylphenol ether sulfate (sodium salt or ammonium salt).

According to the present invention, the nonionic surfactant is at least one selected from the group consisting of octylphenol polyoxyethylene ether, nonylphenol polyoxyethylene ether, dodecylphenol polyoxyethylene ether, laurinol polyoxyethylene ether, and glycol fatty acid ester.

In a specific embodiment of the present invention, the emulsifier is at least one selected from the group consisting of alkylphenol polyether sulfosuccinic acid monoester sodium salt, alkylphenol phosphate, alkylphenol ether ammonium sulfate, nonylphenol polyoxyethylene ether, and dodecylphenol polyoxyethylene ether (OP-10).

In a preferred embodiment of the present invention, the emulsifier is selected from nonylphenol polyoxyethylene ether and dodecylphenol polyoxyethylene ether, wherein the mass ratio of the nonylphenol polyoxyethylene ether to the dodecylphenol polyoxyethylene ether is (0.5-5): 1, for example, it may be 0.5:1, 1:1, 1.5:1, 2:1, 2.5:1, 3:1, 3.5:1, 4:1, 4.5:1, 5:1, and a random value within the range consisting of any two numerical values.

The third aspect of the present invention discloses a method for preparing a polymer emulsion comprising:
(1) blending a mixed monomers, a emulsifier, and water to obtain a monomer emulsion;
(2) irradiating the monomer emulsion to carry out a polymerization to obtain a polymer emulsion; wherein the mixed monomers comprise a monomer A, a monomer B, a cross-linker C, and a monomer D;
wherein the monomer A is represented by CH₂═CH₂—R, wherein the group R is a C₆-C₂₃ alkyl; the monomer B comprises a benzene ring; the monomer D contains a hydrophilic structure;
the monomer A, the monomer B, and the monomer D are used in such amounts that a molar ratio of the benzene ring, the hydrophilic structure, and the group R is (20-70):(1-10):(20-80);
wherein a irradiation absorption dose is within a range of 10 kGy-50 kGy.

In the method for preparing the polymer emulsion of the present invention, when the polymerization reaction is carried out under the irradiation condition, and the irradiation absorption dose is controlled to meet the aforementioned specific range, the polymerization reaction can be uniform, and the finally prepared polymer emulsion has excellent stability. Particularly, when the group R in the monomer A is a C₆-C₂₃ alkyl, it can ensure that the polymer in the prepared polymer emulsion has a high expansion rate when encountering oil and gas and high mechanical properties, and the double bonds of the monomer A can be sufficiently exposed, such that the monomer A can be polymerized with other monomers.

In some specific embodiments of the present invention, the irradiation absorption dose is within a range of 10 kGy-50 kGy, for example, it may be 10 kGy, 15 kGy, 20 kGy, 25 kGy, 30 kGy, 35 kGy, 40 kGy, 45 kGy, 50 kGy, and a random value within the range consisting of any two numerical values, preferably within a range of 10 kGy-30 kGy, an excessively high irradiation absorption dose is apt to cause an implosion, an excessively low irradiation absorption dose may result in an excessively low reaction efficiency and the incomplete reaction of monomers; and use of the scheme of the present invention can ensure that the monomers are completely reacted and an implosion does not occur.

According to the present invention, a irradiation absorption dose rate is within a range of 10-40 Gy/min, for example, it may be 10 Gy/min, 15 Gy/min, 20 Gy/min, 25 Gy/min, 30 Gy/min, 35 Gy/min, 40 Gy/min, and a random value within the range consisting of any two numerical values, preferably within the range of 20-30 Gy/min.

In some specific embodiments of the present invention, the monomer A is used in an amount of 5-80 parts by weight, the monomer B is used in an amount of 10-90 parts by weight, the cross-linker C is used in an amount of 0.5-5 parts by weight, and the monomer D is used in an amount of 0.5-5 parts by weight.

In the present invention, when the used amount of each monomer in the mixed monomers is controlled to satisfy the above range, the prepared polymer may have a high adsorption rate when encountering oil and gas, excellent heat resistance, durability, and mechanical properties; when the polymer is used in the cement slurry, the cement stone obtained after curing of said cement slurry has an expansion when encountering oil and gas and excellent high-temperature resistance.

In the present invention, the monomer A is used in an amount of 5-80 parts by weight, for example, it may be 5 parts by weight, 10 parts by weight, 15 parts by weight, 20 parts by weight, 25 parts by weight, 30 parts by weight, 35 parts by weight, 40 parts by weight, 45 parts by weight, 50 parts by weight, 55 parts by weight, 60 parts by weight, 65 parts by weight, 70 parts by weight, 75 parts by weight, 80 parts by weight, and a random value within the range consisting of any two numerical values; the monomer B is used in an amount of 10-90 parts by weight, for example, it may be 10 part by weight, 15 parts by weight, 20 parts by weight, 25 parts by weight, 30 parts by weight, 35 parts by weight, 40 parts by weight, 45 parts by weight, 50 parts by weight, 55 parts by weight, 60 parts by weight, 65 parts by weight, 70 parts by weight, 75 parts by weight, 80 parts by weight, 85 parts by weight, 90 parts by weight, and a random value within the range consisting of any two numerical values; the cross-linker C is used in an amount of 0.5-5 parts by weight, for example, it may 0.5 part by weight, 1 part by weight, 1.5 parts by weight, 2 parts by weight, 2.5 parts by weight, 3 parts by weight, 3.5 parts by weight, 4 parts by weight, 4.5 parts by weight, 5 parts by weight, and a random value within the range consisting of any two numerical values; the monomer D is used in an amount of 0.5-5 parts by weight, for example, it may be 0.5 part by weight, 1 part by weight, 1.5 parts by weight, 2 parts by weight, 2.5 parts by weight, 3 parts by weight, 3.5 parts by weight, 4 parts by weight, 4.5 parts by weight, 5 parts by weight, and a random value within the range consisting of any two numerical values.

Preferably, the monomer A is used in an amount of 30-60 parts by weight, the monomer B is used in an amount of 40-70 parts by weight, the cross-linker C is used in an amount of 1.5-3.5 parts by weight, and the monomer D is used in an amount of 1.5-2.5 parts by weight.

Further, the group R is a C₆-C₁₈ alkyl.

In the present invention, the monomer A is one or more selected from 1-octaene, 1-tetradecene, 1-hexadecene, 1-octadecene, and 1-eicosene.

According to the present invention, the monomer B is selected from styrene and/or alkyl styrene.

According to the present invention, the cross-linker C is an oil-soluble cross-linker, preferably the cross-linker C is a polymerizable monomer containing at least two carbon-carbon double bonds, such as but not limited to divinyl benzene, and/or N,N-methylenebisacrylamide, more preferably divinyl benzene.

According to the present invention, the monomer D is one or more selected from the group consisting of 2-acrylamido-2-methylpropanesulfonic acid, acrylamide, methacrylic sulfonate, vinyl sulfonate, allyl-containing alkyl alcohol ether sulfosuccinate diester sodium salt, methacrylic acid polyether phosphate ester, and methoxy polyethylene glycol methacrylate.

In a specific embodiment of the present invention, the monomer D is at least two selected from the group consisting of methoxy polyethylene glycol methacrylate, 2-acrylamido-2-methylpropanesulfonic acid, acrylamide, and methacrylic sulfonate; preferably selected from the combination of methoxy polyethylene glycol methacrylate, acrylamide, 2-acrylamido-2-methylpropanesulfonic acid, and/or methacrylic sulfonate, wherein the methoxy polyethylene glycol methacrylate in the monomer D is used in an amount of 0.5-2 wt %, for example, it may be 0.5 wt %, 1 wt %, 1.5 wt %, 2 wt %, and a random value within the range consisting of any two numerical values; acrylamide is used in an amount of 0.5-5 wt %, for example, it may be 0.5 wt %, 1 wt %, 1.5 wt %, 2 wt %, 2.5 wt %, 3 wt %, 3.5 wt %, 4 wt %, 4.5 wt %, 5 wt %, and a random value within the range consisting of any two numerical values.

In some specific embodiments of the present invention, relative to 100 parts by weight of the mixed monomers, the emulsifier is used in an amount of 0.5-15 parts by weight, for example, it may be 0.5 part by weight, 1 part by weight, 1.5 parts by weight, 2 parts by weight, 2.5 parts by weight, 3 parts by weight, 3.5 parts by weight, 4 parts by weight, 4.5 parts by weight, 5 parts by weight, 6 parts by weight, 7 parts by weight, 8 parts by weight, 9 parts by weight, 10 parts by weight, 11 parts by weight, 12 parts by weight, 13 parts by weight, 14 parts by weight, 15 parts by weight, and a random value within the range consisting of any two numerical values, preferably 1-13 parts by weight.

In the present invention, when the used amount of the emulsifier is controlled to satisfy the above ranges, the polymer emulsion and the cement slurry have desirable compatibility, and it is ensured that the cement slurry containing the polymer emulsion is not apt to foam.

In the present invention, the used amount of water is not particularly limited, as long as the mixed monomer and the emulsifier can be sufficiently and uniformly mixed, for example, the used amount of water is 50-200 parts by weight, relative to 100 parts by weight of the mixed monomer.

In some specific embodiments of the present invention, the emulsifier may be an existing emulsifier that can be used for promoting the stability of said emulsion. Preferably, the emulsifier is selected from anionic surfactants and/or nonionic surfactants; the anionic surfactant is at least one selected from the group consisting of sodium dodecylbenzene sulfonate, sodium dodecyl sulfate, sodium alkylphenol ether sulfosuccinate (e.g., Onist2836 emulsifier), sodium alkylphenol ether sulfate (e.g., MS-1 emulsifier), alkylphenol phosphate, and ammonium alkylphenol ether sulfate. The nonionic surfactant is at least one selected from octylphenol polyoxyethylene ether, nonylphenol polyoxyethylene ether (e.g., CO-436 emulsifier), dodecylphenol polyoxyethylene ether (OP-10), methoxy polyethylene glycol methacrylate, laurinol polyoxyethylene ether, and glycol fatty acid ester.

According to the present invention, the nonionic surfactant is at least one selected from the group consisting of octylphenol polyoxyethylene ether, nonylphenol polyoxyethylene ether, dodecylphenol polyoxyethylene ether, laurinol polyoxyethylene ether, and glycol fatty acid ester.

In one embodiment of the present invention, the emulsifier is at least one selected from the group consisting of alkylphenol polyether sulfosuccinic acid monoester sodium salt, alkylphenol phosphate, alkylphenol ether ammonium sulfate, nonylphenol polyoxyethylene ether, and dodecylphenol polyoxyethylene ether.

In a preferred embodiment of the present invention, the emulsifier is selected from nonylphenol polyoxyethylene ether and dodecyl phenol polyoxyethylene ether, wherein the mass ratio of nonylphenol polyoxyethylene ether to dodecyl phenol polyoxyethylene ether is (0.5-5): 1, for example, it may be 0.5:1, 1:1, 1.5:1, 2:1, 2.5:1, 3:1, 3.5:1, 4:1, 4.5:1, 5:1, and a random value within the range consisting of any two numerical values.

In some specific embodiments of the present invention, the existing mixing methods of polymer emulsion may be used. Preferably, the mixing conditions comprise a temperature of 20-40° C., for example, 20° C., 25° C., 30° C., 35° C., 40° C., and a random value within the range consisting of any two numerical values, preferably 25-30° C.; a time of 0.5-2 h, for example 0.5 h, 1 h, 1.5 h, 2 h, and a random value within the range consisting of any two numerical values, preferably 1-2 h; and a stirring speed of 10-100 r/min, for example 10 r/min, 20 r/min, 30 r/min, 40 r/min, 50 r/min, 60 r/min, 70 r/min, 80 r/min, 90 r/min, 100 r/min, and a random value within the range consisting of any two numerical values, preferably 30-50 r/min.

In some specific embodiments of the present invention, the monomer emulsion is irradiated in an oxygen-free environment.

The fourth aspect of the present invention discloses a polymer emulsion prepared with the aforementioned method.

In a specific embodiment of the present invention, the polymer emulsion is subjected to drying, pulverizing, and washing treatment to obtain the polymer according to the first aspect of the present invention.

In some specific embodiments of the present invention, the polymer emulsion has a density within a range of 1-1.05 g/cm³, a solids content within a range of 35-60 wt %, an apparent viscosity within a range of 20-35 mPa's at 25° C., and the latex particles contained in the polymer emulsion have an average particle size within a range of 70-200 nm. If the average particle size of the latex particles is not within a range of 70-200 nm, the particle size is not consistent with the pore size of the cement stone, the latex particles cannot produce the effects of filling pores of the cement stone and reducing the permeability of the cement stone. The latex particles are exactly the polymers disclosed by the first aspect of the present invention.

The polymer emulsion of the present invention has the characteristics of swelling when encountering natural gas and high-temperature resistance. The polymer emulsion is suitable for well cementation of the ultra-deep well.

In the fifth aspect, the present invention discloses a method of using the aforementioned polymer and/or the aforementioned polymer emulsion as a cement slurry self-healing agent.

In the sixth aspect, the present invention discloses a cement slurry, wherein the cement slurry comprises the above-mentioned polymer and/or polymer emulsion.

In some specific embodiments of the present invention, the polymer or the polymer emulsion calculated in terms of polymer is contained in an amount of 5-20 wt %, based on the total weight of the cement slurry. The cement slurry with a desirable heat resistance can be prepared, the cement stone obtained after curing of the cement slurry has a lower elastic modulus and a self-repairing performance when encountering oil and gas.

The seventh aspect of the present invention discloses a method of using the aforementioned cement slurry in well cementation.

In some specific embodiments of the present invention, the use of the cement slurry in well cementation of oil and gas fields at 50-180° C. is preferred.

The present invention will be described in detail below with reference to examples.

In the following examples, the room temperature is within the range of 25-30° C.

The molar ratio of the benzene ring, the hydrophilic structure, and the alkyl side chain in the polymer was measured by the Fourier Transform Infrared Spectroscopy (FTIR), Nuclear Magnetic Resonance (NMR), Differential Scanning calorimetry (DSC), and Inductively Coupled Plasma-Optical Emission Spectrometer (ICP-OES).

The degree of cross-linking of the polymer was measured by a balanced swelling method.

The content of each structural unit in the polymer was determined through the Fourier Transform Infrared Spectroscopy (FTIR) and Nuclear Magnetic Resonance (NMR).

The contents of the emulsifier and the latex particles in the polymer emulsion were measured according to the following methods:

the polymer emulsion was subjected to drying and crushing, then washed with acetone, the powder was dried and weighed to obtain the content of latex particles in the polymer emulsion; the leachate obtained from the washing process was subjected to drying and weighing to obtain the total content of the emulsifier in the polymer emulsion. The leachate was dried to obtain an emulsifier component, the different solvents were used for eluting the emulsifier component, the eluted product was subjected to drying, and the Fourier Transform Infrared Spectroscopy (FTIR), the Nuclear Magnetic Resonance (NMR) testing, and Mass Spectrometry (MS) to determine the types of said emulsifiers and the specific dosage of each emulsifier.

The solid content parameter test method comprises the following steps: about 3-5 g of product was weighed, put into an evaporating dish container, then dried in a baking oven at 80±5° C. to the constant weight, the mass loss was measured. The solid content was obtained by dividing the balance by the initial mass;
the solid content Xₘ of the emulsion was calculated according to the formula (1);

$${X}_{m} = \frac{M 2 - M 0}{M 1 - M 0} \times 100 \% \qquad formula ( 1 )$$

wherein Xₘ denoted the solid content, %;
M₀ denoted the mass of the weighing bottle, the unit was gram (g);
M₁ denoted the total mass of the weighing bottle and the liquid sample, the unit was gram (g);
M₂ denoted the total mass of the weighing bottle and the dried liquid sample, the unit was gram (g).

The particle size parameter was obtained by using a laser particle size method to test the average particle size of latex particles in emulsion, during the testing process, the emulsion was diluted by deionized water until the concentration of the latex particles was 0.01 wt %; the particle size was measured according to the operating instructions of the laser particle analyzer.

The density parameter was measured according to the method stipulated in the China National Standard GB/T 22230-2008.

The reduction rate of natural gas flow velocity was measured by using the device for testing the gas-encountering self-repairing performance of cement sheath (CN 112540025A).

The apparent viscosity parameter was measured according to the method stipulated in the China National Standard GB10247-2008 at 25° C.

The compressive strength and the flexural strength were measured according to the method stipulated in the China National Standard GB/T 19139-2012.

The gas permeability was measured according to the method stipulated in the China National Standard GB10238-2015.

The thickening time was tested through the densification test performed with a HT/HP thickening instrument manufactured by Chandler Corporation in the United States of America (USA), the specific test method was as follows: the cement slurry test temperature was 180° C., the final pressure was 93.9 MPa, the temperature rise time was 91 min, and the measurement was carried out according to the provisions of the China National Standard GB/T 19139-2012. The initial consistency of the cement slurry and the time from 30Bc to 100Bc were recorded or read from the thickening curve.

The filtrate loss was measured according to the provisions in the China National Standard GB/T 19139-2012.

In the following Examples and Comparative Examples, all the raw materials were commercially available.
Emulsifier E1: MS-1 emulsifier;
Emulsifier E2: CO-436 emulsifier;
Emulsifier E3: onist2836 emulsifier;
Emulsifier E4: dodecylphenol polyoxyethylene ether (OP-10);
Monomer D1: acrylamide;
Monomer D2: 2-acrylamido-2-methylpropanesulfonic acid, AMPS.
Monomer D3: sodium methallyl sulfonate.
Monomer D4: methoxy polyethylene glycol methacrylate, with a weight average molecular weight of 1,300 g/mol.

### Example 1

The components were added according to the formula in Table 1, wherein the deionized water was added in an amount of 250 kg, and the monomer emulsion was obtained by stirring and pre-emulsifying the components for 45 min at room temperature. The monomer emulsion was transferred to a 60Co gamma-ray radiation field, and irradiated under an oxygen-free condition, the absorption dose rate was 20 Gy/min, and the absorption dose was 20 kGy, the O/W (Oil-in-Water) type polymer emulsion A1 serving as a self-repairing agent was obtained. A part of polymer emulsion A1 was subjected to drying and crushing, then washed with acetone to obtain a solid phase and a leachate respectively, the solid phase was dried at 150° C. for 4 hours, the polymer P1 was prepared; the leachate was subjected to drying to obtain the emulsifier components. The emulsifier components were eluted in silica gel columns with different solvents so that different components were separated. The eluents were used according to the following sequence: ether:chloroform (volume ratio 1:1), acetone:chloroform (volume ratio 1:1). The eluted product was dried under reduced pressure and subsequently tested. The polymer P1, the emulsifier component A, and the emulsifier component B were tested separately.

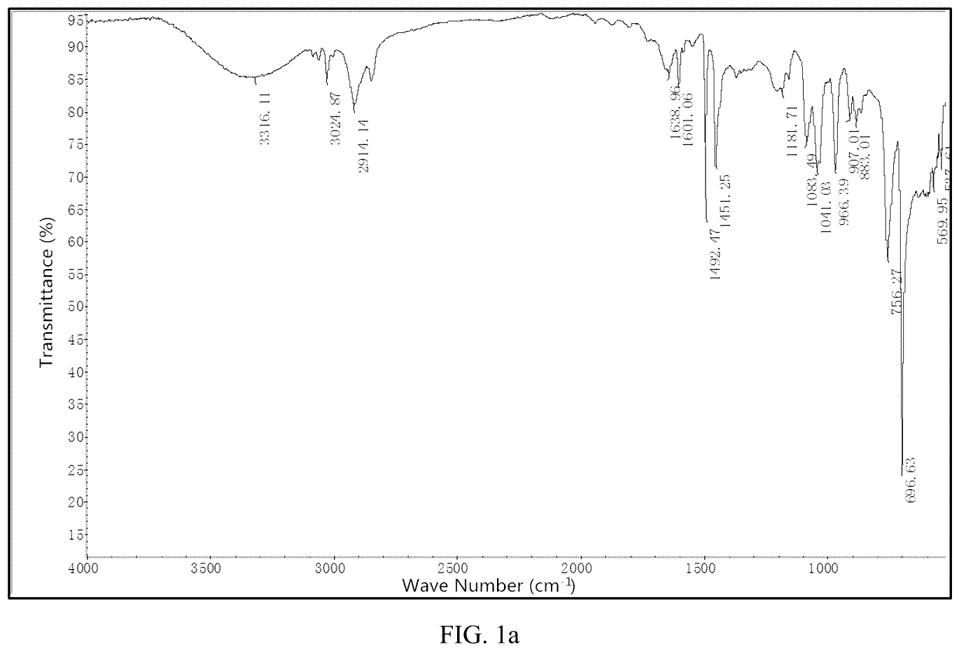

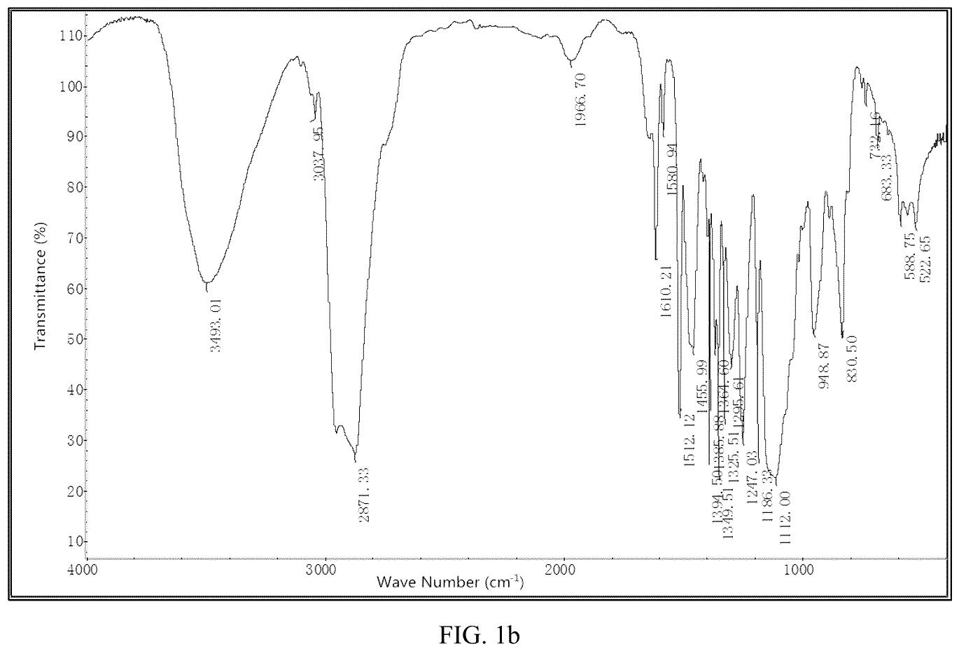

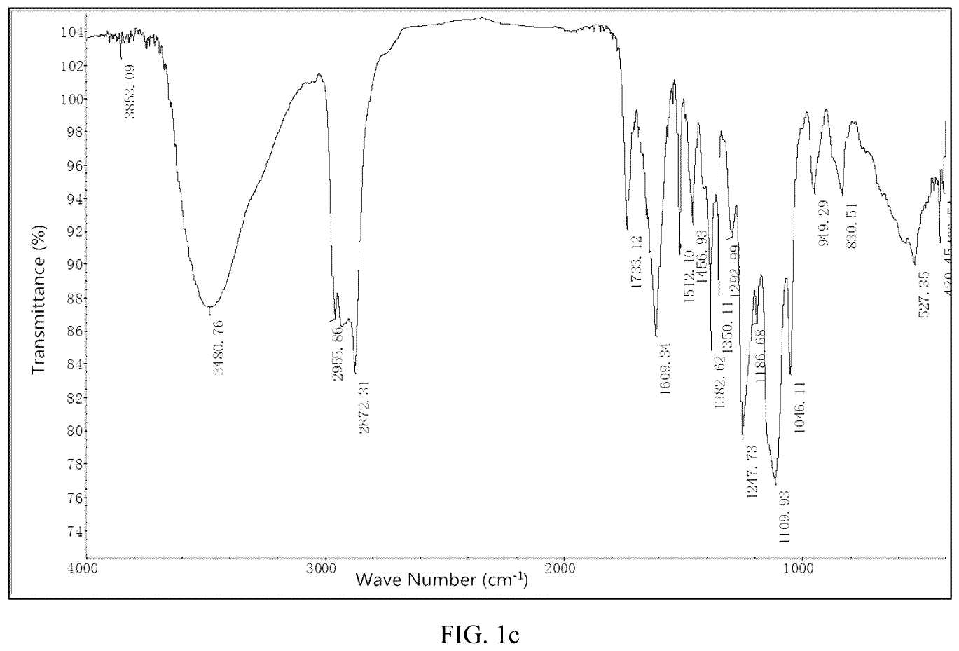

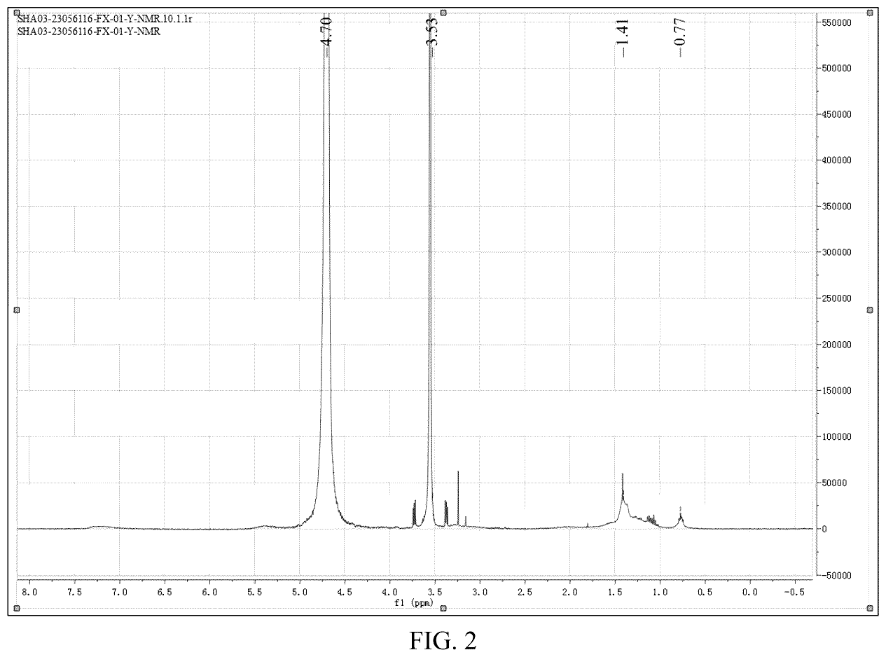

The infrared spectrograms of the polymer P1, the emulsifier component A, and the emulsifier component B were shown in FIG. 1a, FIG. 1b, and FIG. 1c, respectively, wherein 696 cm⁻¹ and 756 cm⁻¹ represented the out-of-plane deformation vibrations of mono-substituted benzene ring=CH, 966 cm⁻¹ denoted the out-of-plane deformation vibrations of (trans 1,4)—CH═CH—, 1451 cm⁻¹ showed the bending vibrations of —CH₂—, 1492 cm⁻¹ and 1601 cm⁻¹ illustrated the skeleton vibrations of benzene ring-CH═CH—, 1638 cm⁻¹ denoted the stretching vibrations of C═C. 3316.1 cm⁻¹, 1616.1 cm⁻¹, and 768.3 cm⁻¹ represented the characteristic absorption peaks of amide groups in PAM chain links. 1081.71 cm⁻¹, 1041.01 cm⁻¹, and 680.2 cm⁻¹ showed the characteristic absorption peaks of the sulfonic acid groups in PAMPS chain links.

In FIG. 1b, 3493 cm⁻¹ represented the stretching vibration of the combined group O—H, 3037 cm⁻¹ denoted the expansion vibration of benzene ring-C—H, 1451 cm⁻¹ showed the bending vibration of —CH₂—, 2871 cm⁻¹ exhibited the expansion vibration of methylene C—H, 1610 cm⁻¹, 1580 cm⁻¹, and 1512 cm⁻¹ illustrated the expansion vibration of benzene ring C═C, 1455 cm⁻¹ and 1349 cm⁻¹ denoted the bending vibration of methylene C—H, 1112 cm⁻¹ showed the stretching vibration of ether bond C—O—C, 830 cm⁻¹ illustrated the out-of-plane bending vibration of benzene ring for substitution of C—H, thus the emulsifier component A was determined to be the emulsifier OP-10.

In FIG. 1C, 3480 cm⁻¹ represented the stretching vibration of the combined group O—H, 2955 cm⁻¹ denoted the stretching vibration of methyl C—H, 2871 cm⁻¹ showed the stretching vibration of methylene C—H, 1733 cm⁻¹ illustrated the stretching vibration of ester bond C═O, 1609 cm⁻¹ and 1512 cm⁻¹ denoted the stretching vibration of benzene ring C═C, 1456 cm⁻¹ and 1350 cm⁻¹ illustrated the bending vibration of methylene C—H, 1109 cm⁻¹ showed the stretching vibration of ether bond C—O—C, 10⁴⁶ cm⁻¹ represented the stretching vibration of sulfonate S=O, and 830 cm⁻¹ illustrated the out-of-plane bending vibration of benzene ring for substitution of C—H. The emulsifier component B was thus identified as emulsifier MS-1.

It can be determined from FIG. 1 that the polymer P1 contained a benzene ring, a hydrophilic structure, and an alkyl side chain; as illustrated by FIG. 1, the content of Na element and S element in the polymer P1 can be determined by normalizing the characteristic absorption peaks of the hydrophilic structure in the infrared spectrogram and the testing performed with the Inductively Coupled Plasma-Optical Emission Spectrometer (ICP-OES), wherein the S element was contained in AMPS, the content of AMPS can be calculated, the Na element was shared by AM and AMPS, the content of AM can be calculated accordingly, and the molar content of the hydrophilic structure in the polymer P1 was further determined.

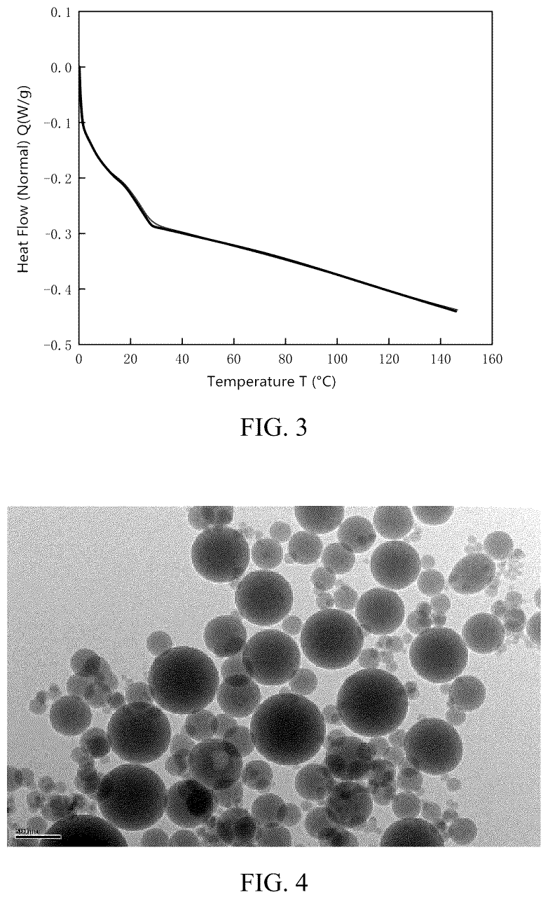

FIG. 3 illustrated a DSC curve of the polymer P1, wherein the glass transition temperature was 23.17° C., and the molar contents of the benzene ring and alkyl side chain in the polymer were calculated based on the glass transition temperature.

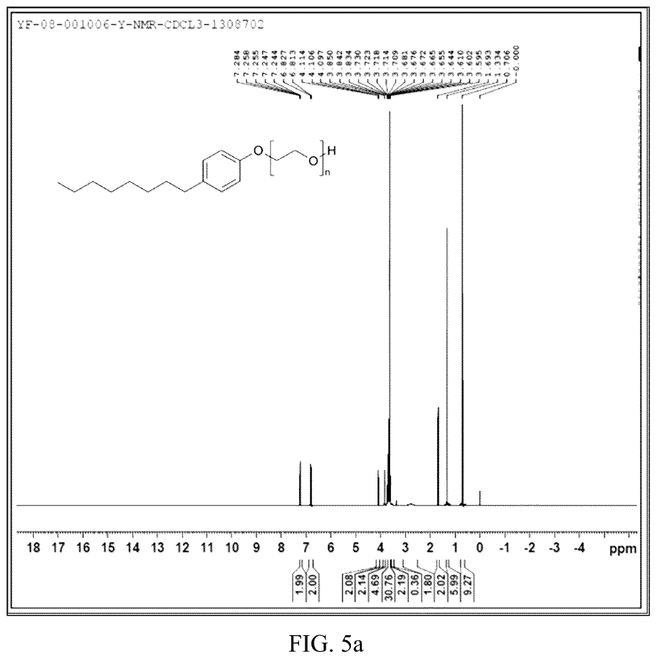

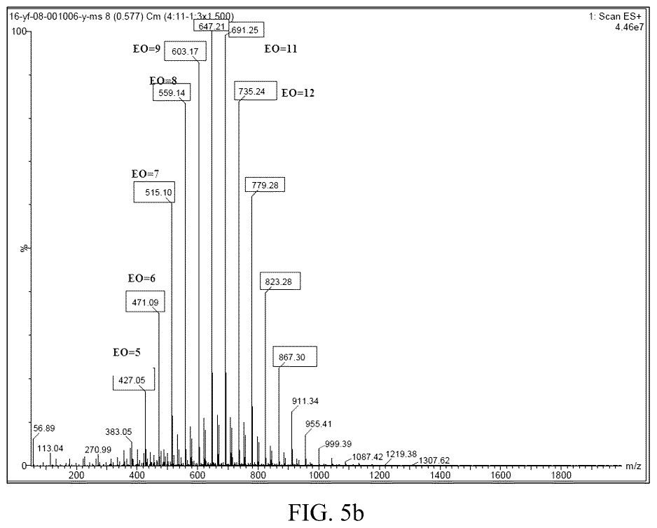

FIG. 5a and FIG. 5b illustrated the NMR spectrogram and MS spectrogram of the emulsifier component A, respectively, wherein 6.8 ppm and 7.2 ppm in FIG. 5a showed the chemical shifts of protonic hydrogen on the benzene ring; 3.60 ppm illustrated the chemical shift of the protonic hydrogen on the EO chain; 0.5 ppm, 1.2 ppm, and 1.8 ppm denoted the chemical shifts of the protonic hydrogens on the alkyl chain. Each peak in FIG. 5b represented the M+1 peak of dodecylphenol polyoxyethylene ether with different numbers of EO (ethylene oxide).

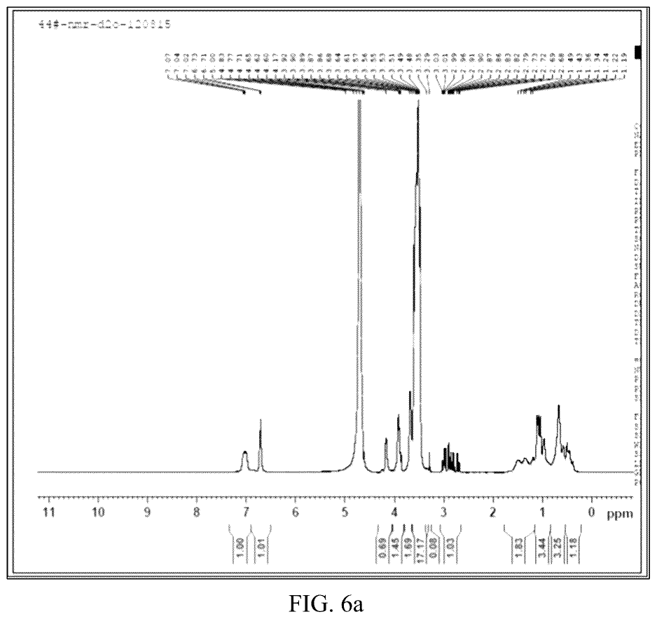

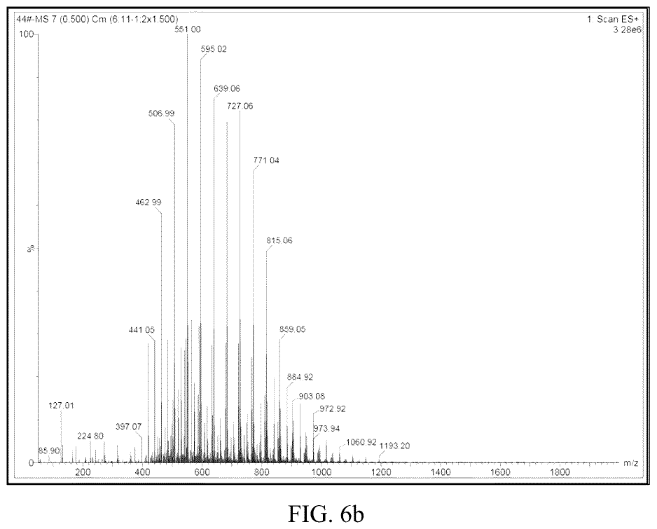

FIG. 6a and FIG. 6b illustrated the NMR spectrogram and MS spectrogram of the emulsifier component B, respectively, wherein 6.8 ppm and 7.2 ppm in FIG. 6a exhibited the chemical shifts of the protonic hydrogen on the benzene ring; 3.60 ppm illustrated the chemical shift of the protonic hydrogen on the EO chain; 4.2 ppm denoted the chemical shift of the protonic hydrogen on the ester bond; 0.5 ppm-1.8 ppm represented the chemical shifts of the protonic hydrogen on the alkyl chain. Each peak in FIG. 6b represented the M+1 peak of sodium alkylphenol ether sulfate with different numbers of EO.

Based on FIG. 1a, FIG. 3 and FIG. 4, the molar contents of the benzene ring and alkyl side chain in polymer P1 can be determined.

The types and contents of the emulsifier components can be determined from FIG. 1b, FIG. 1c, FIG. 5, and FIG. 6.

FIG. 4 illustrated a Scanning Electron Microscope (SEM) photograph of the polymer emulsion A1. As can be seen from FIG. 4, the polymer particles in the polymer emulsion were spherical and had a particle size of about 180 nm.

### Example 2

The components were added according to the formula in Table 1, the monomer emulsion was obtained by stirring and pre-emulsifying the components for 45 min at room temperature. The monomer emulsion was transferred to a 60Co gamma-ray radiation field, and irradiated under an oxygen-free condition, the absorption dose rate was 20 Gy/min, and the absorption dose was 15 kGy, the O/W type polymer emulsion A2 serving as a self-repairing agent was obtained. The polymer emulsion A2 was subjected to drying and crushing, then washed with acetone, and the polymer P2 was prepared; the polymer P2 and the polymer emulsion A2 were tested separately, the test results were shown in Table 2.

### Example 3

The components were added according to the formula in Table 1, the monomer emulsion was obtained by stirring and pre-emulsifying the components for 45 min at room temperature. The monomer emulsion was transferred to a 60Co gamma-ray radiation field, and irradiated under an oxygen-free condition, the absorption dose rate was 20 Gy/min, and the absorption dose was 15 kGy, the O/W type polymer emulsion A3 serving as a self-repairing agent was obtained. The polymer emulsion A3 was subjected to drying and crushing, then washed with acetone, and the polymer P3 was prepared; the polymer P3 and the polymer emulsion A3 were tested separately, the test results were shown in Table 2.

### Example 4

The components were added according to the formula in Table 1, the monomer emulsion was obtained by stirring and pre-emulsifying the components for 45 min at room temperature. The monomer emulsion was transferred to a 60Co gamma-ray radiation field, and irradiated under an oxygen-free condition, the absorption dose rate was 20 Gy/min, and the absorption dose was 50 kGy, the O/W type polymer emulsion A4 serving as a self-repairing agent was obtained. The polymer emulsion A4 was subjected to drying and crushing, then washed with acetone, and the polymer P4 was prepared; the polymer P4 and the polymer emulsion A4 were tested separately, the test results were shown in Table 2.

### Example 5

The components were added according to the formula in Table 1, the monomer emulsion was obtained by stirring and pre-emulsifying the components for 45 min at room temperature. The monomer emulsion was transferred to a 60Co gamma-ray radiation field, and irradiated under an oxygen-free condition, the absorption dose rate was 20 Gy/min, and the absorption dose was 20 kGy, the O/W type polymer emulsion A5 serving as a self-repairing agent was obtained. The polymer emulsion A5 was subjected to drying and crushing, then washed with acetone, and the polymer P5 was prepared; the polymer P5 and the polymer emulsion A5 were tested separately, the test results were shown in Table 2.

### Example 6

The components were added according to the formula in Table 1, the monomer emulsion was obtained by stirring and pre-emulsifying the components for 45 min at room temperature. The monomer emulsion was transferred to a 60Co gamma-ray radiation field, and irradiated under an oxygen-free condition, the absorption dose rate was 20 Gy/min, and the absorption dose was 20 kGy, the O/W type polymer emulsion A6 serving as a self-repairing agent was obtained. The polymer emulsion A6 was subjected to drying and crushing, then washed with acetone, and the polymer P6 was prepared; the polymer P6 and the polymer emulsion A6 were tested separately, the test results were shown in Table 2.

### Example 7

The components were added according to the formula in Table 1, the monomer emulsion was obtained by stirring and pre-emulsifying the components for 45 min at room temperature. The monomer emulsion was transferred to a 60Co gamma-ray radiation field, and irradiated under an oxygen-free condition, the absorption dose rate was 20 Gy/min, and the absorption dose was 20 kGy, the O/W type polymer emulsion A7 serving as a self-repairing agent was obtained. The polymer emulsion A7 was subjected to drying and crushing, then washed with acetone, and the polymer P7 was prepared; the polymer P7 and the polymer emulsion A7 were tested separately, the test results were shown in Table 2.

### Example 8

The components were added according to the formula in Table 1, the monomer emulsion was obtained by stirring and pre-emulsifying the components for 45 min at room temperature. The monomer emulsion was transferred to a 60Co gamma-ray radiation field, and irradiated under an oxygen-free condition, the absorption dose rate was 20 Gy/min, and the absorption dose was 20 kGy, the O/W type polymer emulsion A8 serving as a self-repairing agent was obtained. The polymer emulsion A8 was subjected to drying and crushing, then washed with acetone, and the polymer P8 was prepared; the polymer P8 and the polymer emulsion A8 were tested separately, the test results were shown in Table 2.

### Example 9

The components were added according to the formula in Table 1, the monomer emulsion was obtained by stirring and pre-emulsifying the components for 45 min at room temperature. The monomer emulsion was transferred to a 60Co gamma-ray radiation field, and irradiated under an oxygen-free condition, the absorption dose rate was 20 Gy/min, and the absorption dose was 20 kGy, the O/W type polymer emulsion A9 serving as a self-repairing agent was obtained. The polymer emulsion A9 was subjected to drying and crushing, then washed with acetone, and the polymer P9 was prepared; the polymer P9 and the polymer emulsion A9 were tested separately, the test results were shown in Table 2.

### Example 10

The components were added according to the formula in Table 1, the monomer emulsion was obtained by stirring and pre-emulsifying the components for 45 min at room temperature. The monomer emulsion was transferred to a 60Co gamma-ray radiation field, and irradiated under an oxygen-free condition, the absorption dose rate was 20 Gy/min, and the absorption dose was 20 kGy, the O/W type polymer emulsion A10 serving as a self-repairing agent was obtained. The polymer emulsion A10 was subjected to drying and crushing, then washed with acetone, and the polymer P10 was prepared; the polymer P10 and the polymer emulsion A10 were tested separately, the test results were shown in Table 2.

### Example 11

The components were added according to the formula in Table 1, the monomer emulsion was obtained by stirring and pre-emulsifying the components for 45 min at room temperature. The monomer emulsion was transferred to a 60Co gamma-ray radiation field, and irradiated under an oxygen-free condition, the absorption dose rate was 20 Gy/min, and the absorption dose was 20 kGy, the O/W type polymer emulsion All serving as a self-repairing agent was obtained. The polymer emulsion All was subjected to drying and crushing, then washed with acetone, and the polymer P11 was prepared; the polymer P11 and the polymer emulsion All were tested separately, the test results were shown in Table 2.

### Example 12

The components were added according to the formula in Table 1, the monomer emulsion was obtained by stirring and pre-emulsifying the components for 45 min at room temperature. The monomer emulsion was transferred to a 60Co gamma-ray radiation field, and irradiated under an oxygen-free condition, the absorption dose rate was 20 Gy/min, and the absorption dose was 20 kGy, the O/W type polymer emulsion A12 serving as a self-repairing agent was obtained. The polymer emulsion A12 was subjected to drying and crushing, then washed with acetone, and the polymer P12 was prepared; the polymer P12 and the polymer emulsion A12 were tested separately, the test results were shown in Table 2.

### Example 13

The components were added according to the formula in Table 1, the monomer emulsion was obtained by stirring and pre-emulsifying the components for 45 min at room temperature. The monomer emulsion was transferred to a 60Co gamma-ray radiation field, and irradiated under an oxygen-free condition, the absorption dose rate was 20 Gy/min, and the absorption dose was 20 kGy, the O/W type polymer emulsion A13 serving as a self-repairing agent was obtained. The polymer emulsion A13 was subjected to drying and crushing, then washed with acetone, and the polymer P13 was prepared; the polymer P13 and the polymer emulsion A13 were tested separately, the test results were shown in Table 2.

TABLE 1
(unit, kg)

| | | Example 1 | Example 2 | Example 3 | Example 4 | Example 5 | Example 6 |
|---|---|---|---|---|---|---|---|
| Emulsifier | Kind | E1 | E2 | E3 | E1 | E2 | E1 |
| | Amount | 4.5 | 3 | 1.445 | 6 | 3.6 | 2.1 |
| | Kind | E4 | E4 | E4 | E4 | E4 | E4 |
| | Amount | 3 | 2 | 1.02 | 4 | 2.4 | 1.4 |
| | Total | 7.5 | 5 | 2.465 | 10 | 6 | 3.5 |
| | amount | | | | | | |
| Long chain | Kind | 1-octaene | 1-hexadecene | 1-eicosene | 1-octaene | 1-hexadecene | 1-octaene |
| olefin | Amount | 100 | 120 | 120 | 120 | 130 | 70 |
| Styrene | Kind | Styrene | Styrene | Styrene | Styrene | Styrene | Styrene |
| | Amount | 90 | 100 | 85 | 120 | 95 | 120 |
| Crosslinker | Kind | Divinyl | Divinyl | Divinyl | Divinyl | Divinyl | Divinyl |
| | | benzene | benzene | benzene | benzene | benzene | benzene |
| | Amount | 5 | 4 | 7 | 10 | 4 | 10 |
| Hydrophilic | Kind | D1 | D1 | D1 | D1 | D1 | D1 |
| monomer | Amount | 3 | 3 | 1 | 4 | 4 | 1 |
| | Kind | D2 | D2 | D3 | D2 | D2 | D2 |
| | Amount | 2.5 | 2 | 1.5 | 2 | 2 | 0.5 |
| | Kind | D4 | / | / | D4 | / | D4 |
| | Amount | 2 | / | / | 4 | / | 2 |
| | Total | 7.5 | 5 | 2.5 | 10 | 6 | 3.5 |
| | amount | | | | | | |
| Water | Amount | 250 | 250 | 250 | 250 | 250 | 250 |

| | | Example | Example | Example | Example | Example | Example | Example |
|---|---|---|---|---|---|---|---|---|
| | | 7 | 8 | 9 | 10 | 11 | 12 | 13 |
| Emulsifier | Kind | E1 | E1 | E1 | E1 | E1 | E1 | E1 |
| | Amount | 6.3 | 4.5 | 4.5 | 7.5 | 2.25 | 17.19 | 4.5 |
| | Kind | E4 | E4 | E4 | / | E4 | E4 | E4 |
| | Amount | 4.2 | 3 | 3 | / | 1.5 | 5.73 | 3 |
| | Total | 10.5 | 7.5 | 7.5 | 7.5 | 3.75 | 22.92 | 7.5 |
| | amount | | | | | | | |
| Long chain | Kind | 1-octaene | 1-octaene | 1-octaene | 1-octaene | 1-octaene | 1-octaene | 1-octaene |
| olefin | Amount | 60 | 100 | 100 | 100 | 100 | 100 | 100 |
| Styrene | Kind | Styrene | Styrene | Styrene | Styrene | Styrene | Styrene | Styrene |
| | Amount | 90 | 90 | 90 | 90 | 90 | 90 | 90 |
| Crosslinker | Kind | Divinyl | Divinyl | Divinyl | Divinyl | Divinyl | Divinyl | Divinyl |
| | | benzene | benzene | benzene | benzene | benzene | benzene | benzene |
| | Amount | 5 | 3 | 18 | 5 | 5 | 5 | 5 |
| Hydrophilic | Kind | D1 | D1 | D1 | D1 | D1 | D1 | D1 |
| monomer | Amount | 6 | 3 | 3 | 3 | 3 | 3 | 7.5 |
| | Kind | D2 | D2 | D2 | D2 | D2 | D2 | / |
| | Amount | 2.5 | 2.5 | 2.5 | 2.5 | 2.5 | 2.5 | / |
| | Kind | D4 | D4 | D4 | D4 | D4 | D4 | / |
| | Amount | 2 | 2 | 2 | 2 | 2 | 2 | / |
| | Total | 10.5 | 7.5 | 7.5 | 7.5 | 7.5 | 7.5 | 7.5 |
| | amount | | | | | | | |
| Water | Amount | 250 | 250 | 250 | 250 | 250 | 250 | 250 |

### Example 14

The polymer emulsion was prepared according to the method of Example 1, except that the absorption dose of irradiation was 40 kGy, and the O/W type polymer emulsion A14 serving as a self-repairing agent was obtained. The polymer emulsion A14 was subjected to drying and crushing, then washed with acetone, and the polymer P14 was prepared; the polymer P14 and the polymer emulsion A14 were tested separately, the test results were shown in Table 2.

### Comparative Example 1

The acetate emulsion D1 was prepared by using acetate monomer as the raw material. The specific operations were as follows:

180 kg of deionized water and 3 kg of polyvinyl alcohol KH-20 (The manufacturer was Nippon Synthetic Chemical Industry Co., Ltd.) were added into a reaction kettle, after the material was completely dissolved at 90° C., 3 kg of an emulsifier sodium dodecyl sulfate, 120 kg of vinyl acetate, 80 kg of vinyl versatate, 5 kg of octadecyl methacrylate, and 3 kg of isobutyl polyoxyethylene ether (HPEG, with a molecular weight of 2,400) were subsequently added, 10 kg of an aqueous sodium bicarbonate solution having a mass fraction of 5% was further added, the refluxing and condensing were performed, a stirring process of the polymerization kettle was started, the emulsification was performed for 30 min, 20 kg of an aqueous potassium persulfate solution having a mass fraction of 5% was then added, the reaction was carried out at 90° C. for 5 hours, the kettle was cooled and added with water to ensure that the solid content reached 45%, the reaction product was discharged.

The well cementation cement slurry D1 was prepared by using the vinyl acetate emulsion according to the method of Test Example 1, the test results were shown in Tables 3-5.

### Comparative Example 2

The polymer emulsion was prepared according to the method of Example 1, except that butyl acrylate was used for replacing styrene, and the polymer emulsion D2 was obtained. The polymer emulsion D2 was subjected to drying and crushing, then washed with acetone, and the polymer DP2 was prepared; the polymer DP2 and the polymer emulsion D2 were tested separately, the test results were shown in Table 2.

### Comparative Example 3

The polymer emulsion was prepared according to the method of Example 2, except that butyl acrylate was used for replacing long-chain olefin, the polymer emulsion D3 was obtained. The polymer emulsion D3 was subjected to drying and crushing, then washed with acetone, and the polymer DP3 was prepared; the polymer DP3 and the polymer emulsion D3 were tested separately, the test results were shown in Table 2.

### Comparative Example 4

The polymer emulsion was prepared according to the method of Example 1, except that 1-butene was used for replacing 1-octaene, and the polymer emulsion D4 was obtained. The polymer emulsion D4 was subjected to drying and crushing, then washed with acetone, and the polymer DP4 was prepared; the polymer DP4 and the polymer emulsion D4 were tested separately, the test results were shown in Table 2.

### Comparative Example 5

The polymer emulsion was prepared according to the method of Example 1, except that divinyl benzene was not used, the polymer emulsion D5 was obtained. The polymer emulsion D5 was subjected to drying and crushing, then washed with acetone, and the polymer DP5 was prepared; the polymer DP5 and the polymer emulsion D5 were tested separately, the test results were shown in Table 2.

### Comparative Example 6

The polymer emulsion was prepared according to the method of Example 1, except that the irradiation polymerization was not performed, the potassium persulfate in an amount of 1 wt % of the monomer was used as an initiator at an initiation temperature of 60° C. for an initiation time of 2 h, the temperature was then raised to 90° C., the reaction was carried out for 5 h, a product D6 was obtained. After cooling, the product D6 exhibited three phases which were a water phase, a copolymer phase, and an oil phase respectively, it was detected and determined that the polymer phase was a copolymer formed by styrene, crosslinking monomers, and water-soluble monomers, and the oil phase was 1-octaene.

### Comparative Example 7

The polymer emulsion was prepared according to the method of Example 1, except that the absorption dose of irradiation was 5 kGy, and a product D7 was obtained. The product D7 was not a homogeneous emulsion, but an emulsion exhibiting both an oil phase and a water phase.

### Comparative Example 8

The polymer emulsion was prepared according to the method of Example 1, except that the absorption dose of irradiation was 60 kGy, and a product D8 was obtained. D8 was imploded, the emulsion viscosity was increased rapidly, the stability was damaged, and the product was divided into an oil phase and a water phase.

TABLE 2

| | The molar ratio of benzene ring:hydrophilic | Degree of |
|---|---|---|
| | group:alkyl side chain | cross-linking /% |
| P1 | 44.5:3:43.1 | 2.19% |
| P2 | 38.5:4:68.9 | 2.06% |
| P3 | 33.5:2:64 | 4.32% |
| P4 | 43.5:3:46.9 | 3.46% |
| P5 | 32.8:4:51.7 | 2.06% |
| P6 | 34.6:1:63.9 | 4.32% |
| P7 | 25.5:5:41.3 | 2.75% |
| P8 | 44.5:3:43.1 | 1.31% |
| P9 | 44.5:3:43.1 | 7.88% |
| P10 | 44.5:3:43.1 | 2.19% |
| P11 | 44.5:3:43.1 | 2.19% |
| P12 | 44.5:3:43.1 | 2.19% |
| P13 | 44.5:3:43.1 | 2.19% |
| P14 | 44.5:3:43.1 | 2.19% |
| DP1 | Acetate monomer is used as the raw material | 0 |
| DP2 | Styrene is replaced by butyl acrylate | 2.19% |
| DP3 | Long-chain olefin is replaced by butyl acrylate | 2.19% |
| DP4 | 1-octaene is replaced with 1-butene | 2.19% |
| DP5 | 44.5:3:43.1 | 0 |
| DP6 | — | — |
| DP7 | — | — |
| DP8 | — | — |

| | Structural unit | Structural unit | Structural unit | Structural unit |
|---|---|---|---|---|
| | A/wt % | B/wt % | C/wt % | D/wt % |
| P1 | 49.4 | 44.4 | 2.5 | 3.7 |
| P2 | 52.4 | 43.7 | 1.7 | 2.2 |
| P3 | 55.9 | 39.6 | 3.3 | 1.2 |
| P4 | 46.2 | 46.2 | 3.8 | 3.8 |
| P5 | 55.3 | 40.4 | 1.7 | 2.6 |
| P6 | 34.4 | 59 | 4.9 | 1.7 |
| P7 | 36.3 | 54.4 | 3 | 6.3 |
| P8 | 49.9 | 44.9 | 1.5 | 3.7 |
| P9 | 46.4 | 41.8 | 8.4 | 3.5 |
| P10 | 49.4 | 44.4 | 2.5 | 3.7 |
| P11 | 49.4 | 44.4 | 2.5 | 3.7 |
| P12 | 49.4 | 44.4 | 2.5 | 3.7 |
| P13 | 49.4 | 44.4 | 2.5 | 3.7 |
| P14 | 49.4 | 44.4 | 2.5 | 3.7 |
| DP2 | 49.4 | 44.4^{a} | 2.5 | 3.7 |
| DP3 | 49.4^{a} | 44.4 | 2.5 | 3.7 |
| DP4 | 49.4^{b} | 44.4 | 2.5 | 3.7 |
| DP5 | 50.6 | 45.6 | 0 | 3.8 |
| DP6 | 0 | 87.8 | 4.9 | 7.3 |
| DP7 | 49.4 | 44.4 | 2.5 | 3.7 |
| DP8 | 49.4 | 44.4 | 2.5 | 3.7 |

| | | Emulsifier | | | | |
|---|---|---|---|---|---|---|
| Latex particles | | | | | | Total |
| Kind | Amount | Kind | Amount | Kind | Amount | amount |
| A1 | 45.36 | E1 | 0.98 | E4 | 0.65 | 1.63 |
| A2 | 48.35 | E2 | 0.62 | E4 | 0.41 | 1.03 |
| A3 | 46.51 | E3 | 0.31 | E4 | 0.22 | 0.53 |
| A4 | 51.46 | E1 | 1.15 | E4 | 0.77 | 1.92 |
| A5 | 48.98 | E2 | 0.73 | E4 | 0.49 | 1.22 |
| A6 | 45.47 | E1 | 0.46 | E4 | 0.31 | 0.77 |
| A7 | 40.55 | E1 | 1.48 | E4 | 0.99 | 2.47 |
| A8 | 45.12 | E1 | 0.98 | E4 | 0.66 | 1.64 |
| A9 | 46.87 | E1 | 0.95 | E4 | 0.63 | 1.58 |
| A10 | 45.36 | E1 | 1.63 | / | / | 1.63 |
| A11 | 45.36 | E1 | 0.49 | E4 | 0.33 | 0.82 |
| A12 | 44.99 | E1 | 3.62 | E4 | 1.21 | 4.83 |
| A13 | 45.36 | E1 | 0.98 | E4 | 0.65 | 1.63 |
| A14 | 45.36 | E1 | 0.98 | E4 | 0.65 | 1.63 |
| D1 | 53.24 | Sodium dodecyl sulfate | 2.33 | / | / | 2.33 |
| D2 | 45.36 | E1 | 0.98 | E4 | 0.65 | 1.63 |
| D3 | 48.35 | E2 | 0.62 | E4 | 0.41 | 1.03 |
| D4 | 45.36 | E1 | 0.98 | E4 | 0.65 | 1.63 |
| D5 | 45.36 | E1 | 0.98 | E4 | 0.65 | 1.63 |

| | Density | Solid | Viscosity | Particle | |
|---|---|---|---|---|---|
| | (g/cm³) | content wt % | (mPa · s) | size * (nm) | Appearance |
| A1 | 1.02 | 47 | 32 | 180 | Milky white liquid |
| A2 | 1.02 | 49.38 | 28 | 150 | Milky white liquid |
| A3 | 1.03 | 47.04 | 25 | 160 | Milky white liquid |
| A4 | 1.04 | 53.4 | 29 | 110 | Milky white liquid |
| A5 | 1.02 | 50.2 | 27 | 106 | Milky white liquid |
| A6 | 1.02 | 46.23 | 31 | 109 | Milky white liquid |
| A7 | 1.02 | 43.05 | 31 | 80 | Milky white liquid |
| A8 | 1.01 | 46.77 | 31 | 85 | Milky white liquid |
| A9 | 1.01 | 48.46 | 30 | 88 | Milky white liquid |
| A10 | 1.02 | 47 | 25 | 176 | Milky white liquid |
| A11 | 1.02 | 47 | 28 | 183 | Milky white liquid |
| A12 | 1.01 | 46.64 | 20 | 198 | Milky white liquid |
| A13 | 1.02 | 47 | 28 | 187 | Milky white liquid |
| A14 | 1.01 | 47 | 78 | 52 | Milky white liquid |
| D1 | 1.04 | 55.57 | 44 | 276 | Milky white liquid |
| D2 | 1.02 | 47 | 36 | 80 | Milky white liquid |
| D3 | 1.02 | 49.38 | 32 | 143 | Milky white liquid |
| D4 | 1.01 | 47 | 35 | 82 | Milky white liquid |
| D5 | 1.01 | 47 | 35 | 63 | Milky white liquid |
| D6 | — | — | — | — | Oil-water separation |
| D7 | — | — | — | — | Oil-water separation |
| D8 | — | — | — | — | Oil-water separation |

Note:
* Average particle size of latex particles (polymer)
^{a}Structural units derived from butyl acrylate;
^{b}Structural units derived from 1-butene.

### Test Example 1

The preparation of a well cementation cement slurry B1: the raw materials comprised 100 parts by weight of the Jiahua G-grade oil well cement, 35 parts by weight of quartz sand, 5 parts by weight of a filtrate reducer (Sinopec Research Institute of Petroleum Engineering, SCF—Y), 2 parts by weight of a dispersant (Sinopec Research Institute of Petroleum Engineering, SCS), 3.5 parts by weight of a retarder (Sinopec Research Institute of Petroleum Engineering, SCH-3), and 5 parts by weight of the polymer emulsion A1. The densification test was carried out by using the HT/HP thickening instrument manufactured by Chandler Corporation in the United States of America (USA), the test results were shown in Table 3. After curing the cement slurry, the strength and gas permeability data of the cement block were shown in Table 4. The filtrate loss was measured according to the provisions of the China National Standard GB/T 19139-2012.

The reduction rate of natural gas flow velocity was measured by using the device for testing gas-encountering self-repairing performance of cement sheath (CN112540025A); specifically, the inner cylinder and the outer cylinder of the cement sheath were simultaneously pressurized, the inner cylinder deformed to extrude the cement sheath; the outer cylinder was pressurized to provide a supporting force for the cement sheath and ensure that the rubber sleeve was attached closely to the cement sheath; the inner cylinder of the cement sheath deformed under extrusion to generate the through cracks. The inner cylinder and the outer cylinder were pressurized simultaneously to ensure that an annular gap did not exist, the outer cylinder was gradually depressurized until the air channeling occurred, and at that moment, an annular gap was formed between the rubber cylinder and the cement sheath. Fractures and annular gaps were the major factors causing the failure of the long-term sealing integrity of the wellbore.

The cement stone with artificial cracks was placed in a high-temperature high-pressure curing kettle added with natural gas, to simulate a high-temperature high-pressure environment in a deep well, the flow velocity reduction rate of the natural gas at 100° C. and 5 MPa after curing for 1 day, 2 days, and 3 days were tested respectively.

The flow velocity reduction rate Vₘ of the natural gas was calculated according to the formula (2);

$$Vm = \frac{V 0 - V t}{V0} \times 100 \% \qquad formula ( 2 )$$

wherein Vₘ denoted the solid content, %;
V₀ denoted an initial flow velocity of natural gas penetrating through the cement sheath, the unit was mL/min;
Vₜ denoted the flow rate of natural gas penetrating through the cement sheath after a time t, the unit was mL/min;
the test results were shown in Table 5.

### Test Examples 2-14

The well cementation cement slurries B2-B14 were prepared with the polymer emulsions A2-A14 according to the method of Test Example 1, respectively, the test results were shown in Tables 3-5.

### Comparative Test Examples 1-8

The well cementation cement slurries DB1-DB8 were prepared with the emulsions D1-D8 in Comparative Examples according to the method of Test Example 1, respectively, the test results were shown in Tables 3-5.

TABLE 3

| | Pressure | Temperature | Thickening | Filtrate loss |
|---|---|---|---|---|
| | (MPa) | (° C.) | time (min) | (mL) |
| Polymer | 93.9 | 180 | 283 | 50 |
| emulsion | | | | |
| was not | | | | |
| added | | | | |
| B1 | 93.9 | 180 | 306 | 42 |
| B2 | 93.9 | 180 | 294 | 35 |
| B3 | 93.9 | 180 | 302 | 30 |
| B4 | 93.9 | 180 | 246 | 37 |
| B5 | 93.9 | 180 | 219 | 36 |
| B6 | 93.9 | 180 | 208 | 34 |
| B7 | 93.9 | 180 | 306 | 48 |
| B8 | 93.9 | 180 | 317 | 45 |
| B9 | 93.9 | 180 | 328 | 47 |
| B10 | 93.9 | 180 | 227 | 45 |
| B11 | 93.9 | 180 | 226 | 46 |
| B12 | 93.9 | 180 | 223 | 42 |
| B13 | 93.9 | 180 | 236 | 40 |
| B14 | 93.9 | 180 | 246 | 55 |
| DB1 | 93.9 | 180 | >540 | 41 |
| DB2 | 93.9 | 180 | >540 | 43 |
| DB3 | 93.9 | 180 | >540 | 36 |
| DB4 | 93.9 | 180 | 243 | 39 |
| DB5 | 93.9 | 180 | 259 | 48 |
| DB6 | 93.9 | 180 | — | — |
| DB7 | 93.9 | 180 | — | — |
| DB8 | 93.9 | 180 | — | — |

Compared with a blank group without the addition of the polymer emulsion, when the cement slurry was doped with the polymer emulsion of the present invention, the thickening time of the cement slurry at high temperature was not obviously affected, and the high-temperature high-pressure filtrate loss was significantly reduced.

TABLE 4

| | Compressive | Flexural | Gas |
|---|---|---|---|
| | strength | strength | permeability |
| Cement | after | after | (millidarcy, |
| slurry No. | 48 h (MPa) | 48 h (MPa) | or MD) |
| Polymer emulsion | 28.4 | 3.05 | 0.214 |
| was not added | | | |
| B1 | 25.9 | 3.94 | 0.165 × 10⁻³ |
| B2 | 26.8 | 3.62 | 0.137 × 10⁻³ |
| B3 | 24.3 | 3.47 | 0.164 × 10⁻³ |
| B4 | 16.5 | 3.12 | 0.32 × 10⁻³ |
| B5 | 27.6 | 3.16 | 0.64 × 10⁻³ |
| B6 | 28.4 | 3.23 | 0.48 × 10⁻³ |
| B7 | 15.4 | 4.53 | 0.27 × 10⁻³ |
| B8 | 24.1 | 3.53 | 0.31 × 10⁻³ |
| B9 | 25.7 | 3.62 | 0.28 × 10⁻³ |
| B10 | 27.4 | 3.54 | 0.13 × 10⁻³ |
| B11 | 27.1 | 3.42 | 0.14 × 10⁻³ |
| B12 | 14.2 | 3.05 | 2.2 × 10⁻³ |
| B13 | 24.7 | 4.01 | 0.15 × 10⁻³ |
| B14 | 24.8 | 3.62 | 0.18 × 10⁻³ |
| DB1 | — | — | — |
| DB2 | — | — | — |
| DB3 | — | — | — |
| DB4 | — | — | — |
| DB5 | 26.3 | 3.28 | 0.12 × 10⁻³ |
| DB6 | — | — | — |
| DB7 | — | — | — |
| DB8 | — | — | — |

Compared with a blank group without the addition of the polymer emulsion, when the cement slurry was doped with the polymer emulsion of the present invention, the flexural strength of the cement stone obtained from curing of said cement slurry can be obviously improved, and the gas permeability of the cement stone was reduced.

TABLE 5

| | Reduction rate of natural | | | |
|---|---|---|---|---|
| | gas flow velocity (%) | | | |
| | 0 day | 1 day | 2 days | 3 days |
| Polymer | 0 | 0 | 0 | 0 |
| emulsion | | | | |
| was not | | | | |
| added | | | | |
| B1 | 0 | 98.3% | 100% | 100% |
| B2 | 0 | 92.4% | 100% | 100% |
| B3 | 0 | 86.7% | 97.3% | 100% |
| B4 | 0 | 82.3% | 90.7% | 98.7% |
| B5 | 0 | 76.8% | 87.2% | 95.7% |
| B6 | 0 | 73.6% | 83.4% | 92.3% |
| B7 | 0 | 65.8% | 72.4% | 80.3% |
| B8 | 0 | 63.2% | 68.5% | 74.1% |
| B9 | 0 | 55.1% | 56.3% | 55.6% |
| B10 | 0 | 97.2% | 100% | 100% |
| B11 | 0 | 96.4% | 100% | 100% |
| B12 | 0 | 93.3% | 100% | 100% |
| B13 | 0 | 94.2% | 100% | 100% |
| B14 | 0 | 12.3% | 21.6% | 24.3% |
| DB1 | — | — | — | — |
| DB2 | — | — | — | — |
| DB3 | — | — | — | — |
| DB4 | 0 | 0 | 0 | 0 |
| DB5 | 0 | 0 | 0 | 0 |
| DB6 | — | — | — | — |
| DB7 | — | — | — | — |
| DB8 | — | — | — | — |

In the blank group, the flow velocity of natural gas penetrating through the cement stone fractures was not reduced, and the cement stone generally lacked the self-repairing capability after the fractures were generated; by adding the polymer emulsion of the present application, even if the cement stone was damaged to generate cracks, the flow velocity of natural gas passing through the cracks was reduced, the cement stone had a self-repairing performance; according to the preferred embodiment of the present invention, the reduction rate of natural gas flow velocity was 100% when the curing process reached the third day, which indicated that the polymer emulsion formed a plugging at the cement stone cracks, the long-term sealing performance of the cement stone can be ensured.

The above content describes in detail the preferred embodiments of the present invention, but the present disclosure is not limited thereto. A variety of simple modifications can be made regarding the technical solutions of the present invention within the scope of the technical concept of the present invention, including a combination of individual technical features in any other suitable manner, such simple modifications and combinations thereof shall also be regarded as the content disclosed by the present disclosure, each of them falls into the protection scope of the present invention.

1-21. (canceled)

22. A polymer comprising a benzene ring, a hydrophilic structure, and a C₆-C₂₃ alkyl side chain; wherein a molar ratio of the benzene ring to the hydrophilic structure to the alkyl side chain is (20-70):(1-10):(20-80);
the polymer has a degree of cross-linking within a range of 1-10%.

23. The polymer according to claim 22, wherein the molar ratio of the benzene ring to the hydrophilic structure to the alkyl side chain is (20-50):(1-5):(40-80);
and/or, the polymer has a degree of cross-linking within a range of 2-5%.

24. The polymer according to claim 22, wherein the alkyl side chain is a C₆-C₁₈ alkyl side chain;
and/or, the hydrophilic structure is at least one derived from the amide group, sulfonic acid group, sulfonate group, carboxyl, carboxylate, phosphoric acid, phosphate group, and a polyether.

25. The polymer according to claim 22, wherein the polymer comprises a structural unit A from long chain olefins, a structural unit B from styrene, a structural unit C from a crosslinker monomer, and a structural unit D from a hydrophilic monomer.

26. The polymer according to claim 25, wherein the long chain olefin is one or more selected from C₈-C₂₅ α-olefins;
the crosslinker monomer is selected from oil-soluble crosslinkers;
the hydrophilic monomer is one or more selected from the group consisting of 2-acrylamido-2-methylpropanesulfonic acid, acrylamide, methacrylic sulfonate, vinyl sulfonate, allyl-containing alkyl alcohol ether sulfosuccinate diester sodium salt, methacrylic acid polyether phosphate ester, and methoxy polyethylene glycol methacrylate.

27. The polymer according to claim 25, wherein the structural unit A is contained in an amount of 5-80 wt %, the structural unit B is contained in an amount of 10-90 wt %, the structural unit C is contained in an amount of 0.5-5 wt %, and the structural unit D is contained in an amount of 0.5-5 wt %, based on the total weight of the polymer.

28. A polymer emulsion comprises latex particles and an emulsifier;
wherein the latex particles are composed of the polymer according to claim 22.

29. The polymer emulsion according to claim 28, wherein the latex particles have an average particle size within a range of 70-200 nm.

30. The polymer emulsion according to claim 28, wherein the polymer emulsion has a density within a range of 1-1.05 g/cm³;
and/or, the polymer emulsion has a solid content within a range of 35-60 wt %;
and/or, the polymer emulsion has an apparent viscosity within a range of 20-35 mPa's at 25° C.;
a content of the latex particles is 35-60 parts by weight, and a content of the emulsifier is 0.5-5 parts by weight, based on 100 parts by weight of the polymer emulsion.

31. The polymer emulsion according to claim 28, wherein the emulsifier is selected from anionic surfactants and/or nonionic surfactants.

32. The polymer emulsion according to claim 31, wherein the anionic surfactant is at least one selected from the group consisting of sodium dodecylbenzene sulfonate, sodium dodecyl sulfate, sodium alkylphenol ether sulfosuccinate, alkylphenol phosphate, and sodium alkylphenol ether sulfate;
the nonionic surfactant is at least one selected from the group consisting of octylphenol polyoxyethylene ether, nonylphenol polyoxyethylene ether, dodecylphenol polyoxyethylene ether, laurinol polyoxyethylene ether, and glycol fatty acid ester.

33. A method for preparing a polymer emulsion comprising:
(1) blending a mixed monomers, a emulsifier, and water to obtain a monomer emulsion;
(2) irradiating the monomer emulsion to carry out a polymerization to obtain a polymer emulsion;
wherein the mixed monomers comprise a monomer A, a monomer B, a cross-linker C, and a monomer D;
wherein the monomer A is represented by CH₂—CH₂—R, wherein the group R is a C₆-C₂₃ alkyl;
the monomer B comprises a benzene ring; the monomer D contains a hydrophilic structure;
the monomer A, the monomer B, and the monomer D are used in such amounts that a molar ratio of the benzene ring, the hydrophilic structure, and the group R is (20-70):(1-10):(20-80);
wherein a irradiation absorption dose is within a range of 10 kGy-50 kGy.

34. The method according to claim 33, wherein the emulsifier is selected from anionic surfactants and/or nonionic surfactants.

35. The method according to claim 33, wherein the irradiation absorption dose is within a range of 10 kGy-30 kGy;
a irradiation absorption dose rate is within a range of 10-40 Gy/min.

36. The method according to claim 33, wherein the monomer A is used in an amount of 5-80 parts by weight, the monomer B is used in an amount of 10-90 parts by weight, the cross-linker C is used in an amount of 0.5-5 parts by weight, and the monomer D is used in an amount of 0.5-5 parts by weight.

37. The method according to claim 36, wherein the monomer A is used in an amount of 30-60 parts by weight, the monomer B is used in an amount of 40-70 parts by weight, the cross-linker C is used in an amount of 1.5-3.5 parts by weight, and the monomer D is used in an amount of 1.5-2.5 parts by weight.

38. The method according to claim 33, wherein the monomer A is one or more of C₈-C₂₅ α-olefins;
and/or, the monomer B is styrene and/or alkyl styrene;
and/or, the cross-linker C is selected from oil-soluble cross-linkers;
and/or, the monomer D is one or more selected from the group consisting of 2-acrylamido-2-methylpropanesulfonic acid, acrylamide, methacrylic sulfonate, vinyl sulfonate, allyl-containing alkyl alcohol ether sulfosuccinate diester sodium salt, methacrylic acid polyether phosphate ester, and methoxy polyethylene glycol methacrylate.

39. The method according to claim 33, wherein the emulsifier is used in an amount of 0.5-15 parts by weight, relative to 100 parts by weight of the mixed monomers;
and/or, the water is used in an amount of 50-200 parts by weight, relative to 100 parts by weight of the mixed monomers.

40. A cement slurry comprising a polymer according to a polymer emulsion according to claim 28.

41. The cement slurry according to claim 40, wherein the polymer emulsion calculated in terms of polymer is contained in an amount of 5-20 wt %, based on the total weight of the cement slurry.
